(19) United States
(12) Patent Application Publication
(10) Pub. No.: US 2007/0201830 A1
(43) Pub. Date: Aug. 30, 2007

(54) Systems And Methods For Production, Delivery, Recording, And Viewing Of Video And Similar Content Primarily Intended To Be Viewed In Step-Frame/Frame-Advance Mode

(76) Inventors: Marshal T. Rose, Sacramento, CA (US); Brenten C. Hahn, North Hollywood, CA (US); David Hope, Laguna Beach, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/677,692

(22) Filed: Feb. 22, 2007

Related U.S. Application Data
(63) Continuation-in-part of application No. 11/636,271, filed on Dec. 8, 2006.
(60) Provisional application No. 60/751,170, filed on Dec. 16, 2005.

(51) Int. Cl. H04N 7/00

(52) U.S. Cl. 386/95

(57) ABSTRACT

Systems and methods are disclosed for processing a video data streams having an input adapted for receiving and processing the video signal and rendering an output signal in a digital format, detecting a particular code within an individual frame of the processed signal that identifies the type of frame that contains the code, and storing the identified frame in a retrievable memory location of the system. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### BACKGROUND

The present application claims the benefit of and is a Continuation-In-Part of Non-Provisional Application No. 11/636,271 filed Dec. 8, 2006 and U.S. Provisional Application No. 60/751,170 filed Dec. 16, 2005.

1. Field of the Inventions

The present invention generally relates to a system and method of video and similar content production, delivery, recording, and viewing and, more specifically, to a system and method of video and similar content production, delivery, recording, and viewing where such content is primarily intended to be viewed using “step-frame/frame-advance” mode.

2. Background Information

The type of content contemplated for step-frame/frame-advance mode viewing includes but is not limited to advertising content, entertainment content, informational content, educational content and the like. Such content may be produced as video or other means that allows such content to be transmitted and received by viewing devices, including but not limited to video monitors, television sets, computers, cell phones, personal digital media players, PDA's, gaming devices and the like. Delivery includes but is not limited to delivery by various means, including but not limited to television broadcast, cable distribution, internet distribution or access such as video streaming, and wireless distribution, to television sets, computers, cell phones, PDA's, gaming devices and the like. Recording includes recording of such content so delivered on a recording device such as a videotape recorder, digital video disc recorder, personal digital media player, Personal Digital Video Recorder (“PDVR”), computer hard drive, or similar means. To “step-frame/frame-advance means that a viewer plays back the content from the recording device and moves forward and/or backward through the content and views a series of single frames one frame at a time, perhaps using a device such as a remote control that controls such viewing device, and spends as much time as they like looking at each individual frame.

Television programming and television commercial advertisements have traditionally been produced with the intent of the viewer watching the content in real time or quasi-live mode. If, for example, a commercial is nominally 30 seconds long, the producers and broadcasters of the commercial have always intended that it take 30 seconds for the commercial to be broadcast, and that the viewer take 30 seconds to view the commercial. Similarly, if a television program is 30 minutes long, including commercials, then the producers and broadcasters of the program have always intended that the viewer watch this in real time, and thus take 30 minutes to do so.

With the introduction of home videotape recorders it became possible for a home television viewer or other viewer to record, or videotape, a television program and/or commercial for later playback. Typically such devices also allow the viewer to “fast-forward” through any part of the program, and thus not watch that part of the program. Typically, viewers would use this feature to fast-forward through the commercials that had been broadcast within the program, in order to watch the program without such commercial interruptions. However, as only a small percentage of viewers actually recorded a particular program on videotape recorders for later viewing, and as fast-forwarding through the commercials using videotape technology is not particularly accurate or user friendly, the percentage of viewers that actually use this technique is not believed to be particularly high. Nevertheless, advertisers miss the opportunity to reach these viewers.

More recently, new technologies have been introduced that are gradually replacing the videotape machine as the means of recording television programs and commercials in the home and elsewhere. In addition, due to the many benefits offered by these new devices, it is believed that they will continue to gain in market penetration, and may ultimately replace the home videotape recorder in many more homes, and elsewhere. One such leading technology is the Personal Digital Video Recorder (PDVR) that utilizes new digital technologies to allow a viewer to record significant amounts of television programming and commercials easily, and store them on a hard drive. One of the leading technologies in this area currently is that provided by TiVo™. PDVR's are also commonly referred to as PVR's, DVR's, TiVo™ and the like.

In addition to allowing a viewer to more easily record significant amounts of television programming, some offering the ability to record many hours of programming and commercials, many of these devices also incorporate other features that are an improvement over earlier videotape technologies. One of these features, typically, allows a viewer to more easily fast-forward through, or “skip” the commercials that were initially broadcast within the program. Another feature typically allows a viewer to step-frame/frame-advance through any or all of the recorded content, and view each individual frame for as long as they wish. The result of the various improvements incorporated in these new technologies used for recording television programs and commercials is that a much higher proportion of viewers who have access to these technologies are expected to record a much higher percentage of the programs they ultimately watch. In addition, a much higher percentage of these viewers are also expected to use these technologies to fast-forward through or skip watching the commercials.

At present, advertising in general, and the traditional 30-second television commercial in particular, support the vast majority of the television industry in the USA and beyond. Advertisers, often through their advertising agencies or media buying companies, spend billions of dollars per year in the USA with television networks, cable companies and others, to buy time within television programming in order to air their commercials. Typically these advertisers pay for these time slots, or advertising spots, based upon the number of viewers and/or type of viewers (by demographic breakdown or otherwise) that they believe will ultimately see their commercial. In addition, they buy time in particular television programs that they believe already attract the kind of viewer that they are trying to reach.

As such, as more and more viewers gain access to these new technologies, and as more and more of them use these technologies to skip through the commercials, advertisers are likely going to want to pay less and less for the time slots within these programs. This is likely to lead to a number of fundamental problems for advertisers, advertising agencies, television networks, cable channels, television producers and others who deliver advertising-supported programming. For example, advertisers recognize the fact that advertising on television is one of their most important means of advertising their products and services, etc. However, if more and more viewers use new technologies to avoid watching the commercials, then over time advertisers will find traditional television commercials to be less and less effective. Similarly, if fewer people are watching the commercials, advertising agencies may likely find that their clients, the advertisers, will spend less money hiring them to create and to buy time to air these commercials.

Meanwhile, television networks, cable channels and other current and future media delivery systems will likely receive less and less money to air traditional commercials. This in turn will significantly reduce these networks' revenues and profitability. Similarly, these networks, cable television channels and other delivery systems will therefore have less and less money to pay for television programs from producers and production companies, who will also thus see their revenues and profits threatened.

These various segments of the television industry currently recognize these potential threats to their industry posed by these new technologies. In view of this, many companies within each of these segments are already looking for ways in which to ensure that advertisers continue to have access to television viewers and that viewers continue to see advertising messages on television. For example, many companies are now using different techniques, such as “product placement”, to incorporate advertising messages within the actual body of a television program rather than within a traditional commercial that is aired within a program. The logic behind this new strategy is that, although viewers can easily fast-forward past a traditional commercial without missing any part of the actual program, they cannot easily fast-forward though a product that is actually used within the program itself.

Another technique being tried by the industry to solve this problem is “Sponsored Programming” whereby an advertiser contributes to the production cost of a program in return for the producers of that program incorporating advertising messages and/or product placements subtly within the program. However, many if not all of these techniques are limited in scope, as it is often difficult to use product placement and similar techniques to communicate the many aspects of a company's products or services that can currently be communicated via a traditional commercial. For example, although an advertiser may be able to communicate to a viewer the new styling of a new model car by placing the car in a television drama series where it is driven by one of the characters in the series, it is more difficult to explain “dealer discounts” or promote upcoming “sales”. Similarly, it is also often difficult to incorporate a wide range of advertising messages within a sponsored program, whose main objective is to provide the viewer with an entertaining television program and not to bombard them with advertising messages. Indeed, many viewers, and more recently some television industry groups, do not like this trend of incorporating myriad advertising messages within a program, and there is thus both viewer and industry pressure to reduce and/or eliminate these techniques.

Another way in which advertisers and their agencies are attempting to get viewers to continue to view their commercials is by producing commercials that are more entertaining in their own right, in the hope that viewers will want to watch the commercials and will thus not be tempted to fast-forward through them. However, although some commercials may have become more entertaining in recent years, research still appears to show that most viewers with access to these new technologies still elect to avoid the commercials altogether.

In yet another technique being tried to ensure that viewers still see advertising messages, many television networks and cable companies are placing commercial messages over the top of a television program while it is being broadcast. Often these messages are superimposed at the bottom, or in one or more comers of the screen. For example, often these messages are used by such channels to advertise future programs that will appear on the channel, or to show the channel's logo, etc. However, many viewers find these advertising messages distract them from the program they are trying to watch and, as such, these messages often tend to alienate many viewers. Also, as these messages are being shown while a viewer is primarily trying to watch the actual program, there is some question as to the effectiveness of this type of advertising. Consequently, it is clear that advertisers, advertising agencies, and the television industry at large are actively looking for new ways to use television to get viewers to watch a wide range of advertising messages, and thus to prevent these new technologies from destroying their ability to do this. However, it is also clear that none of the current methods being tried effectively offer advertisers, their agencies, or the various television companies a satisfactory range of options to do this.

Another aspect of the current television industry that it is important to understand when considering the benefits of the current invention is the infomercial industry. Infomercials are typically long form commercials, often of 30 minutes or one hour in length. These commercial programs are usually produced to look like an informative television program, but typically promote a particular product that the program producers are trying to sell to viewers. As with typical programs and commercials, these infomercials are designed for real time viewing. Infomercial producers tend to purchase 30 minute or one hour blocks of time from television networks or cable channels in which to air these long form commercials. Typically these channels have blocks of time available, often late at night and during the early hours of the morning, where there are not enough viewers tuning in to the channel to justify airing actual programs. By selling this time to infomercial producers these channels can then make additional revenues from these time slots.

The infomercial industry is also likely to be adversely affected by these new technologies. As more and more viewers are able to watch programs they have recorded on their PDVR's whenever they wish, there are likely to be fewer and fewer viewers who will be tuning in to a particular channel late at night to watch the programming being broadcast in real time by these channels. Thus these viewers will not be tuning in at the times that typical infomercials are being aired. Also, it is unlikely that infomercials will be the type of program that many viewers will record for future viewing, as they tend to be more of an impulse view. However, the fact that such channels are willing to sell large blocks of time to advertisers, and that these time slots may be of less value to infomercial producers in the future, provides another potential use and advantage of the current invention as will be explained. Three other ways by which advertisers get their advertising and marketing messages across to their potential clients are through the use of printed catalogues, brochures, and other print advertising.

Generally catalogues tend to be produced by manufacturers and retailers, and often consist of glossy photographs, drawings, and brief descriptions of a whole range of different products offered for sale by such retailers. Manufacturers and retailers in a whole range of industries produce such catalogues. For example catalogues are produced by clothing retailers such as “GAP™”, and “L.L. BEAN™”, Christmas gift retailers, gardening supply companies, home electronics retailers, and the like. Catalogues also often include the prices of each product, as well as a detailed description of how a potential customer can order the products available in the catalogues and have them delivered to their homes. Catalogues are often mailed directly to the homes of potential customers, or are available from the retail stores of the companies who produce them.

In contrast, brochures are generally produced by both manufacturers and retailers, and often consist of a range of glossy photographs, drawings, key facts, and very detailed descriptions of the products being offered for sale. For example a car manufacturer such as BMW™ may produce a brochure about a specific car, or a specific range of cars. Often brochures are only available directly from the manufacturer on request, or may be available at key locations where potential buyers can pick up a copy. For example a buyer interested in buying a new BMW™ may be able to pick up a brochure or series of brochures on the latest models from the local BMW™ dealership.

Print advertising is a term that not only incorporates catalogues and brochures, but also covers advertising placed in newspapers, magazines, and other printed matter. Advertisers use such print advertising to advertise new products, new features of old products, enhance product brand names, offer discount coupons, advertise “Sales” and so on. Over the years, types of print advertising have developed that cross over these various categories, so that these descriptions should be not be considered exclusive or exhaustive.

Print advertising, especially catalogues and brochures, has a number of advantages over television commercial advertising, while television commercial advertising has a number of advantages over print advertising. As such, many advertisers use a combination of television advertising and print advertising when advertising and marketing their products and services. For example, advertisers can often use print advertising to highlight more products, or more features, facts, figures, and photographs of products than can typically be shown in a 30-second commercial. Also, print advertising can more easily be used to offer discount coupons, notify buyers of local sales, and the like. In addition, and particularly relevant to the current invention, it is well known that potential customers will retain copies of certain types of print advertising, especially catalogues and brochures, for a period of time, and will go back and read them at their convenience, time and time again.

However, print advertising also has a number of weaknesses when compared to television commercial advertising. Most importantly, even those catalogues with the glossiest photographs cannot match the visual and audio impact of a 30-second commercial. In addition, some catalogues and brochures can be very expensive both to produce, and to deliver to potential customers. A catalogue or brochure must be produced, printed, and often mailed to each individual prospective customer. Often many brochures and catalogues, as well as other print ads, are sent to customers who have absolutely no interest in them and who typically throw them in the trash. As such, there is often a lot of waste involved in this method of production and delivery, not only the actual cost of manufacture and shipping, but the wasted time and effort, and also the huge waste of natural resources such as all the paper that is thrown away.

Also, these catalogues and brochures often take up a lot of room in a potential customer's home or office, and may be discarded for this fact alone. Also, customers who save a whole range of catalogues and brochures may have difficulty locating the one they want at the time they want, or may forget which catalogue contains the specific product they are interested in. Also, if a catalogue is not mailed to a specific potential customer, or if a potential customer is unable to visit a place where a catalogue or brochure is available (such as the BMW™ dealership), then such a potential customer may never see such a catalogue or brochure, leading to a missed sales opportunity. Furthermore, both catalogue and TV advertising tend to be limited in the number of distinct images they present of a given product. This may also lead to lost sales. For example, a potential customer may be reluctant to order, say, a couch on the basis of a quick glimpse of it in a TV ad or a single picture in a catalogue. However, while a furniture catalogue showing full-page front, back, side and top views of every item would be much more informative, and more likely to lead to sales, it would likely be prohibitively expensive to produce and mail using current techniques. Similarly, it is believed that many companies who would like to use catalogues and brochures as part of their business strategy currently find the cost of doing so using current techniques prohibitively expensive.

As can be seen, there is a need for an improved method and system for producing and delivering advertising and sponsorship messages to a television audience. Furthermore, there is a need for a method of producing and delivering advertising and sponsorship messages to a television audience that will encourage viewers to record and watch the advertising and sponsorship messages instead of fast-forwarding through them when using new technologies such as PDVR's. Still further, there is a need for a method of producing and delivering content that is intended to be watched one frame at a time in “step-frame/frame-advance” mode. Still further, there is a need for a cheaper and easier method and system of delivering content such as catalogues, brochures, print advertising, and other types content normally printed and distributed on paper. Still further there is the need for a method and system of delivering such content via television broadcast or cable or via the Internet so that it can be recorded on a device such as a PDVR and played back at the viewer's leisure using “step-frame/frame-advance” mode. Still further there is a need for production, delivery and recording of content that may be viewed one frame at a time at the speed the viewer wants.

Still further, there is a need for a method and system for advertising that is effective and, therefore, will be widely used by advertising agencies and advertisers. Still further, there is a need for a method and system for advertising that encourages advertisers to buy television timeslots and that is preferred by advertisers over printed advertising. Still further, there is a need for a method and system for advertising that eliminates printing and distributing of printed advertisement materials. Still further, there is a need for a method and system for advertising that can deliver far more information and in much greater detail than typical prior art television commercials or printed advertising materials while utilizing existing, widely available, and widely used electronic equipment. Still further, there is a need for a method and system for advertising that enables the provided content to be easily recorded, stored, and accessed. There has still further arisen a need for a method and system for advertising that enables an individual to select desired content for easily and effectively recording, storing, and viewing with already existing electronic equipment.

### SUMMARY OF THE INVENTION

In one aspect of the present invention, a method of production and delivery of content comprises the steps of: creating at least one individual frame from source material of step-frame/frame advance content; transmitting at least one individual frame; receiving and recording at least one individual frame; playing back the recorded at least one individual frame in step-frame/frame-advance mode; and viewing the content in step-frame/frame-advance mode.

In another aspect of the present invention, a method of production and delivery of searchable content comprises the steps of: creating an individual frame from source material of step-frame/frame-advance content; marking the individual frame for electronic identification; transmitting and receiving the individual frame at a standard frame rate; searching for the individual frame; identifying the individual frame; recording the individual frame; playing back the individual frame in step-frame/frame-advance mode; and viewing the content in step-frame/frame-advance mode.

In a further aspect of the present invention, a method for simultaneous production and delivery of real-time content and step-frame/frame-advance content includes the steps of: converting source material of real-time content into a first still image for real-time viewing, wherein the first still image occupies a first section of an individual frame; converting source material of step-frame/frame-advance content into a second still image for step-frame/frame-advance viewing, wherein the second still image occupies a second section of the same individual frame; creating at least one additional individual frame, possibly in the same manner, and putting the individual frames in sequence; transmitting the sequence of the individual frames at a standard frame rate; receiving and recording the sequence of the individual frames; playing back the recording of the sequence in real-time mode for viewing the real-time content in real time; and playing back the recording of the sequence in step-frame/frame-advance mode for viewing the step-frame/frame-advance content in step-frame/frame-advance mode.

In a still further aspect of the present invention, a method for production and delivery of content for sequential viewing includes the steps of: creating a first sequence of first individual frames containing real-time content; creating a second sequence of second individual frames containing step-frame/frame-advance content; editing the first sequence of the first individual frames together with the second sequence of the second individual frames creating a final sequence, wherein the first sequence and the second sequence are in succession; transmitting the final sequence at a standard frame rate; receiving and recording the final sequence; playing back the first sequence of first individual frames for viewing in real time; and playing back the second sequence of second individual frames for viewing in step-frame/frame-advance mode.

In a still further aspect of the present invention, an information system comprises: a production device that converts source material images of step-frame/frame-advance content into individual frames; a delivery medium that transmits the individual frames; a recording device that receives and records the individual frames, and wherein the recording device plays back the individual frames in step-frame/frame-advance mode; and a viewing device that displays the step-frame/frame-advance content in step-frame/frame-advance mode.

In yet another aspect of the present invention, a method or system for recording, separation, and retrieval of combined real-time and step-frame/frame-advance content comprises: tagging the step-frame/frame-advance frames using embedded coding that may include metadata information; transmitting the tagged frames together with standard real-time video content; receiving the combined video signal using a PDVR or similar type device; detecting and retrieving tagged and/or metadata content; and, depending on the tagged or metadata content information, removing or copying the tagged or metadata content frames to a location or locations separate from the real time content.

These and other features, aspects, and advantages of the present invention will become better understood with reference to the following drawings, descriptions and claims.

### BRIEF DESCRIPTION OF THE DRAWINGS

Features, aspects, and embodiments of the inventions are described in conjunction with the attached drawings, in which:

FIG. 1 illustrates a single-frame Master File used to generate Step-frame Video Content.

FIG. 2 illustrates a Cover Page File used to generate Step-frame Video Content.

FIGS. 3a-3e illustrate a series of Category Sub-Master Files used to generate Step-frame Video Content.

FIGS. 4a-4c illustrate individual pages created in a single category using a category Sub-Master File used to generate Step-frame Video Content.

FIGS. 5a-5c illustrate Step-frame Video Content in which the left half of the video screen appears to be a conventional real-time video TV commercial, while the right half of the screen is for Step-frame Video Content.

FIGS. 6a-6c illustrate real-time video confined to the top half of a screen, while the bottom half is left blank for Step-frame Video Content.

FIGS. 7a-7c illustrate photos cropped to the proportions of the blank areas in the previously created real-time video shown in FIG. 6.

FIGS. 8a-8c illustrate the insertion of still photos as Step-frame Video Content in the blank bottom sections of the individual frames of a real-time video.

FIG. 9 is a block diagram schematically representing a content production and delivery system, according to the present invention;

FIG. 10 is a flow diagram showing a first method according to the present invention;

FIG. 11 is a flow diagram showing a second method according to the present invention;

FIG. 12 is a flow diagram showing a third method according to the present invention; and

FIG. 13 is a flow diagram showing a fourth method according to the present invention.

FIG. 14 is a flow diagram depicting the video data stream through the basic components according to the present invention.

FIG. 15 is a flow diagram depicting an exemplary scenario for PDVR detection of step-frame/frame-advance coded frames within a “South Park” video broadcast.

FIG. 16 is a flow diagram depicting an exemplary scenario for PC (or other computer device) detection of step-frame/frame-advance coded frames within a Web streaming video news clip.

FIG. 17 presents an algorithm that effects some exemplary step-frame/frame-advance detection and identification functions of the present invention.

FIG. 18 presents exemplary codes that can be embedded into video frames intended for viewing in step-frame/frame-advance mode.

FIG. 19 depicts an exemplary meta-information directory according to the present invention for recorded and archived step-frame/frame-advance data.

FIG. 20 depicts an exemplary user interface window providing selection choices to the user according to the present invention.

FIG. 21 presents an exemplary algorithm according to the present invention for interpreting codes embedded within video frames.

FIG. 22 depicts an exemplary user interface window providing choices of other code-linked step-frame/frame-advance frames, a Web link, and a telephone link.

FIG. 23 presents an exemplary algorithm according to the present invention for detecting a future referenced frame and pausing on that frame.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

A video production, such as a television program or commercial, like a motion picture, is actually a rapid sequence of individual frames of still images. In the case of the American NTSC television standard, there are approximately 30 of these frames per second. Thus, it is possible to use television to deliver, for example, approximately 900 individual frames or pictures to a standard NTSC television set during the course of a 30-second commercial. Similarly, it is also possible to deliver approximately 108,000 individual frames of picture during the course of an hour. All calculations made in this application are based on this 30 fps NTSC standard. While in many other countries, the standard television frame rate is different, the calculations that apply to these other frame rates would be readily apparent to persons skilled in the field of the invention. Also, certain types of video transmission, such as online video streaming, often are streamed at alternative standard rates, due to compression and other issues. In such instances standard frames per second shall include those commonly used in the industry to transmit all forms of moving images. Furthermore, a viewer can use either certain traditional videotape recorders, or new technologies such as PDVR's, digital video disc recorders, and personal digital media players, to record video or similar content, initiate and then pause the video playback, view individual video frames, and step-frame/frame-advance through sequences of still video images one frame at a time

Additionally, another key feature of many of these new technologies, such as PDVR's and digital video disc recorders, and one that is pertinent to this invention, is that many of these devices include technology that more easily allows a viewer to both record content such as a program or commercial, and view individual frames of such content they have thus recorded in step-frame/frame-advance mode, spending as much time as they like viewing each individual frame. In addition, as these new technologies evolve to allow the delivery of content such as video content to other devices such as cell phones, personal digital media players, computers, gaming devices, and the like, the manufacturers of these devices are also likely to include similar features to allow for the recording and playback of content in step-frame/frame-advance mode.

The following are descriptions of two exemplary processes for creating and assembling Step-frame Video Content.

“Step-frame Video Content” is defined as any video content that is created or assembled with the intent that the viewer will view the content one still frame at a time.

### EXAMPLE 1

A catalogue for “Claudia's Closet,” a retailer of women's lingerie, sleepwear, swimsuits and accessories. The goal is to create Step-frame Video Content that looks like and can be used in a similar way to the retailer's traditional paper catalog. In this example, all of the content of each frame is intended to be viewed in step-frame/frame-advance mode.

There are 3 main steps:

Step 1 is Creation of “pages.” Using computer graphics software such as Adobe Photoshop, create individual “pages” (files) that combine photos and text like the pages of a paper catalogue.

Step 2 is Importing the “pages” into an editor. Import the individual Page Files into a computerized nonlinear editing system such as Avid for editing.

Step 3 is Sequencing the “pages.” Use the nonlinear editor to edit together the Page Files in the proper sequence. The resulting Step-frame content can then be broadcast. Alternatively, the resulting Step-frame content can be edited together with other real time and/or Step-frame content as part of a program or commercial and then broadcast as combined content.

Step 1: Creation of “pages.”

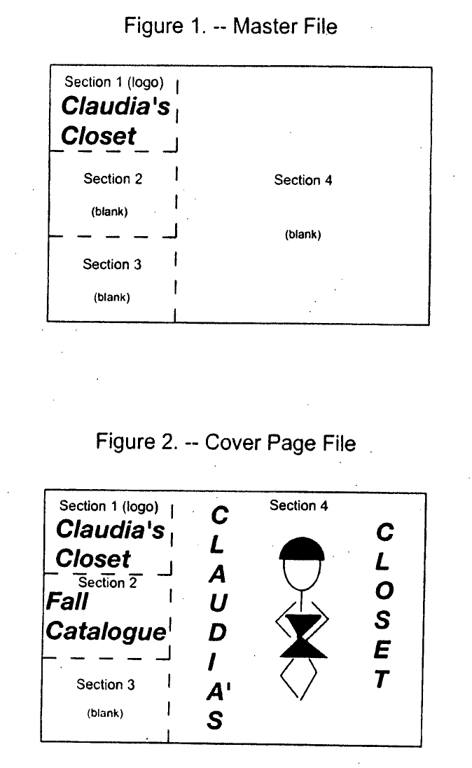

Create a single-frame Master File, using computer graphics software such as Adobe Photoshop. (FIG. 1) This Master File will serve as a template for all of the individual catalogue “pages.” In our example, the Master File will have 4 Sections:

The company logo

Category text (“Lingerie,” “Sleepwear,” “Swimwear,” “Clothing.” “Footwear.”.)

Page number

Photo(s) of the individual items for sale, combined with descriptive text, prices, etc.

Insert the company logo in Section 1 (see FIG. 1), and any other graphics or background art common to all pages of the catalogue into the Master File. Leave Sections 2, 3, and 4 blank. Save as the Master File.

Create a series of single-frame files for Section 4 (see FIG. 1) of each page of the catalogue plus the cover page. Each of these files will consist of combining relevant photos, text and graphics using computer graphics software such as Adobe Photoshop.

Create a Cover Page. Take one copy of the Master File and insert the “Cover” graphic file (created in Step B) in Section 4 of the Master File, and insert the Cover Page text into Section 2. Save the Cover Page File. (FIG. 2)

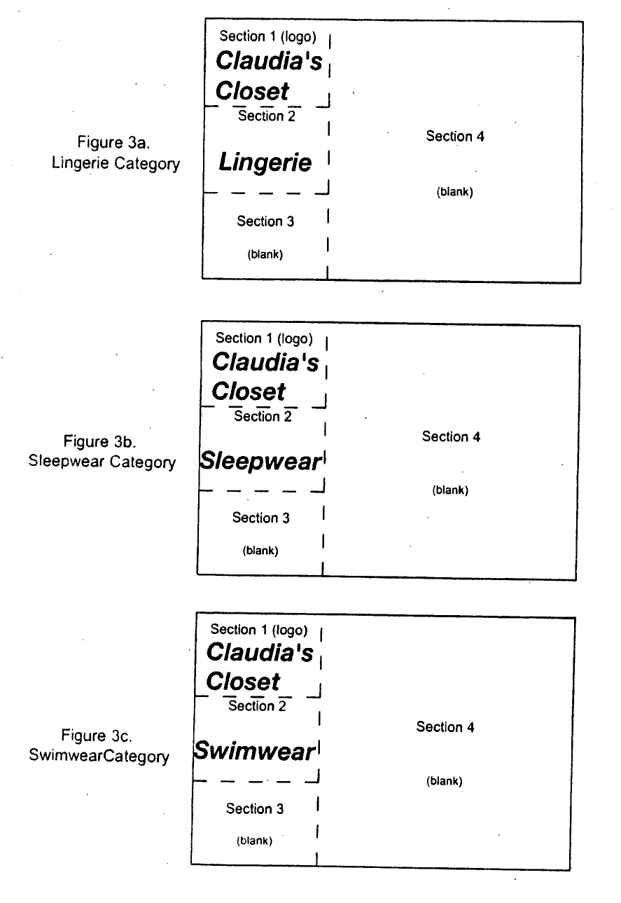

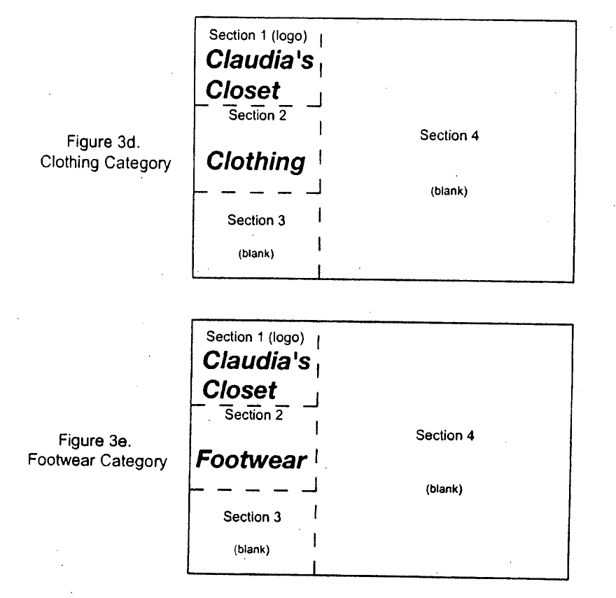

Create a series of Category Sub-Master Files, one for each category, e.g., Lingerie (FIG. 3a), Sleepwear (FIG. 3b), Swimwear (FIG. 3c), Clothing (FIG. 3d), and Footwear (FIG. 3e). Using copies of the Master File, insert specific Category text into Section 2. Sections 3 and 4 are blank. Save these Category Sub-Master Files. These Category Sub-Master Files will serve as templates to create individual Page Files.

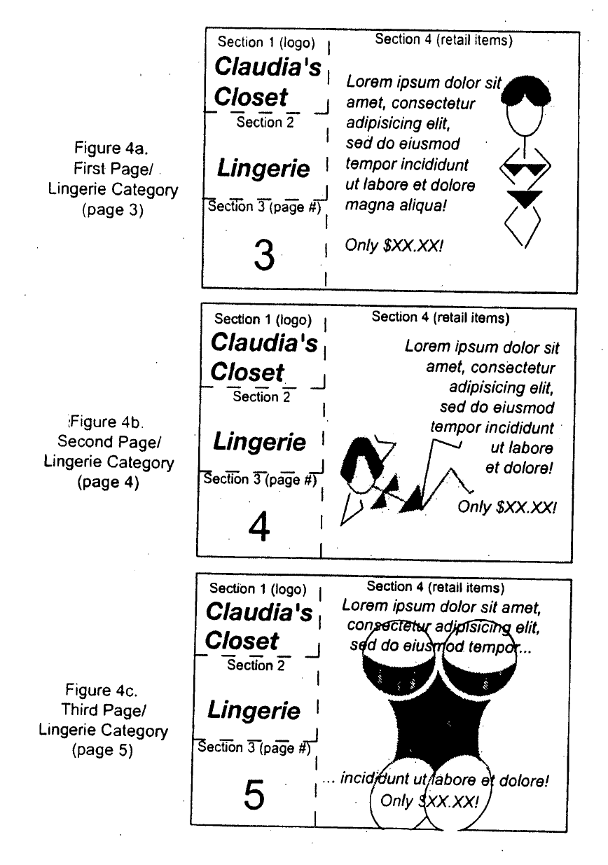

Create all the individual pages in the Lingerie Category. Using the Lingerie Sub-Master File (FIG. 4a), insert the first Lingerie “page” file into Section 4. Place a page number in Section 3. This first page number will be 3 (the Cover is page 1, the Table of Contents will be page 2). Save this new assembly as a Page File. Repeat this process for all Lingerie pages, numbering sequentially as shown in FIGS. 4b-4c. Assuming there are 20 Lingerie pages, they will be numbered 3 through 22. Once completed, each of the 20 Lingerie pages will be alike in sections 1 and 2, with different page numbers in section 3 and different content in Section 4.

Create and save all the individual Page Files for the remaining Categories in the same manner as in Step IE above. Number the pages accordingly so that each page of the catalogue has a unique number.

Create and save Table of Contents Page File. Number this page, Page 2.

Create and save any other miscellaneous individual Page Files in the same manner, for example an index page, a how-to-order page, etc.

Step 2: Importing the “pages” into an editor.

Import the individual computer graphics Page Files into a computerized nonlinear editing system such as Avid.

Step 3: Sequencing the “pages.”

Use the nonlinear editor to edit together the Page Files in the proper sequence. The resulting step-frame/frame-advance content can then be broadcast. Alternatively, the resulting step-frame/frame-advance content can be edited together with other real time and/or step-frame/frame-advance content as part of a program or commercial and then broadcast as combined content.

It is also possible to use a variation of this process to create a form of step-frame/frame-advance video content in which certain sections of each frame are intended to be viewed as conventional real-time video, while other sections of each frame are intended to be viewed in step-frame/frame-advance mode. For example, it would be possible to create step-frame/frame-advance video content in which the left half of the video screen appears to be a conventional real-time video Claudia's Closet TV commercial, while the right half of the screen is the Claudia's Closet step-frame/frame-advance catalogue.

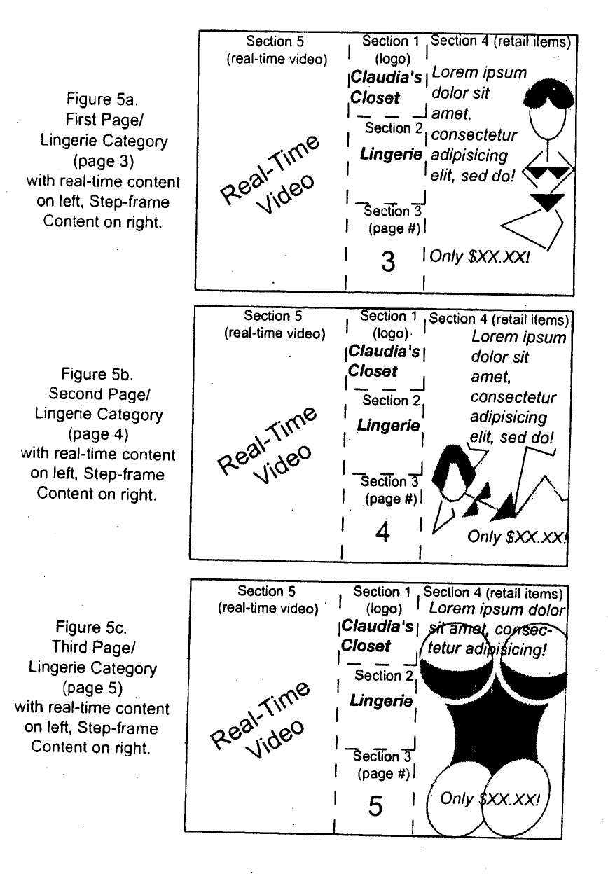

This could be done by creating a fifth section of each frame of the catalogue as described above, such section being on the left-hand side of each frame (FIG. 5), and inserting within such section individual frames of the real-time video commercial, using standard computer-graphics and video editing technology. (FIGS. 5a, 5b, and 5c).

### EXAMPLE 2

A commercial for a car, say, the new 2007 Cromwell Saloon. In this example, at least a portion of the TV screen will contain conventional real-time video all the way through, but part of the commercial will also contain step-frame/frame-advance content in a portion of the screen.

There are 3 main steps:

Step 1: Creation of the real-time part of the commercial.

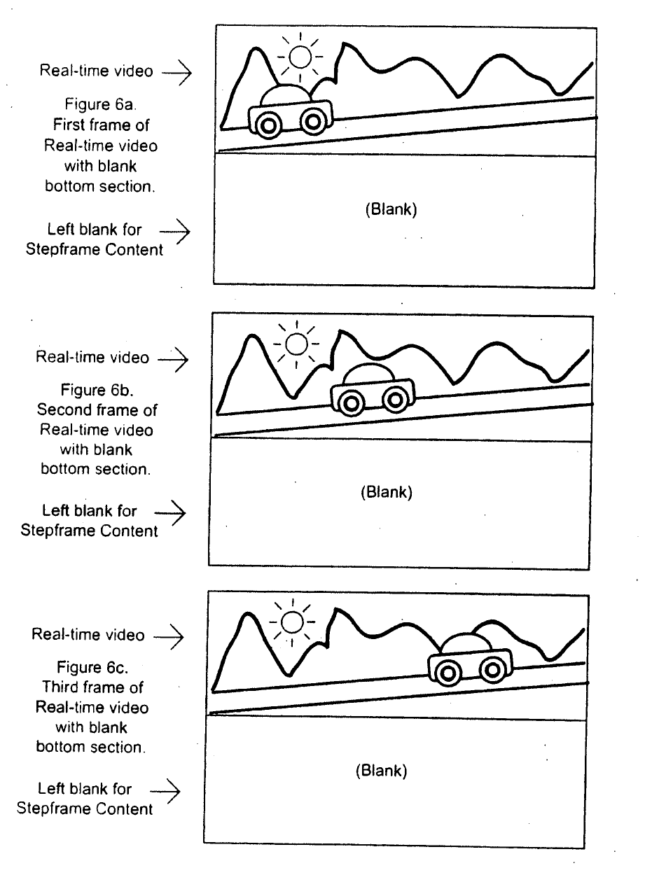

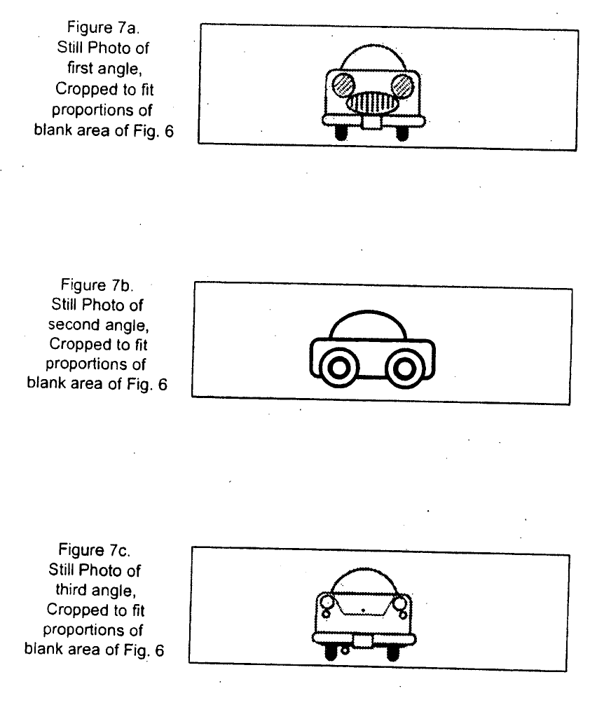

Film the 2007 Cromwell racing through mountains and deserts, parked at a fancy country club, etc. Record voiceover and music. The beginning of the voiceover might say, “Introducing the Cromwell Saloon—new for '07!” while we see a full-screen shot of the car. Then the voiceover might talk about luxury, performance, styling, and so forth, while we see the car racing up mountain switchbacks and breaking the speed limit in the desert. During this section, however, the real-time video of the car is confined to the top half of the screen, while the bottom half is left blank. (FIG. 6) The conclusion of the commercial could be conventional, full-frame real-time video.

Sep 2: Creation of the Step-frame Content of the car commercial.

Take still photographs of the exterior of the car from several different angles. Repeat this exact process for every color the car comes in. Or, alternatively, take only one series of still photos and, using Photoshop or the like, make a series of photos in every color. Then follow these steps to make series of photos of the available interior colors and trim options as well. Crop these photos to the proportions of the blank areas in the previously created real-time video. (FIG. 7).

Step 3: Putting the Step-frame Content in the blank sections of the video.

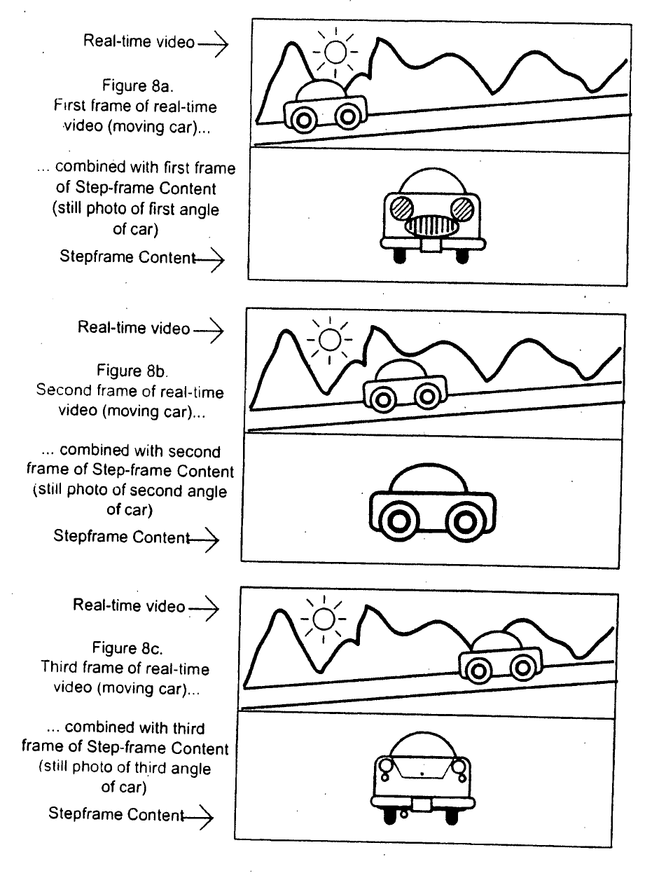

Using a nonlinear video editor, insert the still photos of the car (every angle/ color/interior option) in the blank bottom sections of the individual frames of the real-time mountain and desert video. (FIG. 8). When this finished, and commercial is played back from a PDVR, the viewer then has the option of watching the middle mountain/desert video in real-time, or perusing all the angles, colors, and interiors in step-frame/frame-advance mode.

An essence of the current invention is therefore to produce programs, commercials and other types of content that are specifically intended to be viewed in step-frame/frame-advance mode, i.e. one frame at a time, and viewed at a rate and for a period of time chosen by the viewer that allows them to see every piece of detail contained within each individual frame. In this method, content, and particularly video content, is produced with the intent that it will be recorded as it is initially broadcast or transmitted, but will then be viewed at some future time in step-frame/frame-advance mode.

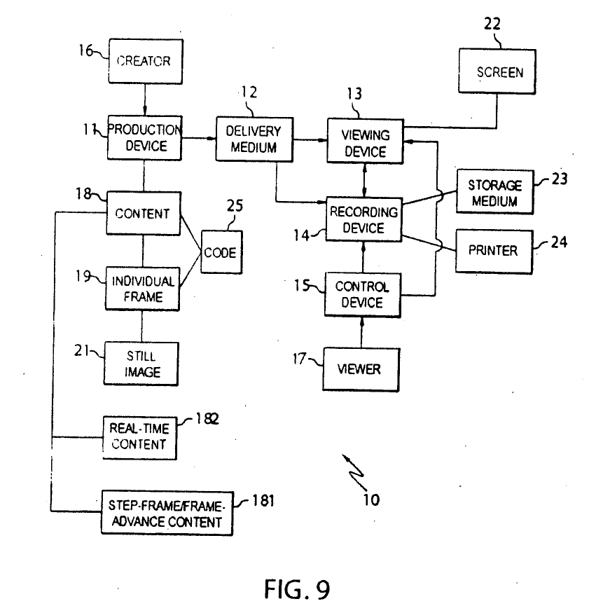

FIG. 9 is a block diagram schematically representing a content production and delivery system, such as an advertisement and information system 10, according to one exemplary embodiment of the present invention. The advertisement and information system 10 may include a production device 11, a delivery medium 12, a viewing device 13, a recording device 14, and a control device 15. The delivery medium 12 may include, but is not limited to, television broadcast distribution, cable distribution, internet distribution such as by video streaming, wireless distribution, and satellite distribution. The viewing device 13 may include, but is not limited to, video monitors, television sets, computers, cell phones, PDA's, and gaming devices. Television sets may include sets having a standard resolution and sets having a high definition resolution, and which may be able to receive analog and/or digital signals. The viewing device 13 may include a screen 22 or utilize a separate monitor. The recording device 14 may be any device that includes a storage medium 23. The storage medium 23 may be, for example, a hard drive. Recording devices 14 may include, for example, videotape recorders (VTR), digital videodisc recorders, personal digital video recorders (PDVR's), computer hard drives, personal digital media players, or similar means.

The production device 11 may be used by a creator 16 to produce content 18, such as, but not limited to, advertising content, entertainment content, informational content, and educational content to be viewed by a viewer 17. Content 18 may include step-frame/frame-advance content 181 that may be intended to be viewed only in step-frame/frame-advance mode as a series of still images that can be viewed one frame at a time at a speed and direction (forward and/or backward) determined by the viewer 17. The step-frame/frame-advance content 181 may be created from images of source material, such as catalogue pages, brochure pages, photographs, images and/or data. The step-frame/frame-advance content 181 may be interactive, for example, by including a link to a Website and/or the Internet, by including direct links to a phone number, such as dial from your computer or set top box, etc, by being printable, or by sending the content 181 to a computer or other device. Content 18 may further include real-time content 182 to be viewed in real time. The content 18 may be encoded for electronic identification and may include a code 25.

The production device 11 may be used to produce content 18 as a sequence of individual frames 19 of still images 21. Thus, step-frame/frame- advance content 181 may be a sequence of individual frames 19 intended to be viewed in step-frame/frame-advance mode, where the viewer 17 moves forward and/or backward through the content 181 and views a sequence of individual frames 19 one frame at a time. The viewer may spend as much time as desired looking at each individual frame and may move forward and/or backward from frame to frame as desired. Furthermore, real-time content 182 may be a sequence of individual frames 19 intended to be viewed in real-time mode, where the viewer 17 sees a motion picture, which is a rapid sequence of individual frames 19 of still images 21, for example 30 individual frames 19 per second.

Each frame 19 or sequence of individual frames 19 may be encoded in such a way that the recording device 14 can electronically identify them. These electronically encoded identifiers could be used for purposes including but not limited to: 1. Identifying an advertisement by its retail category sponsor i.e. Cars, Cameras, Watches; 2. Identifying an advertisement by its specific sponsor, i.e. BMW, Nikon, Rolex; 3. Identifying content by demographic target, i.e. Senior Women, Basketball fans, Overweight Men;

These encoded identifiers could also be used to mark the beginning and end of step-frame/frame-advance video content or the beginning and end of various sections of step-frame/frame-advance video content. For example, in the case of the Claudia's Closet Catalogue, these identifiers could be used to mark the beginning and end of the catalogue, plus the beginning pages of each section (Lingerie, Sleepwear, Swimwear, etc.) of the catalogue. Examples of electronic identifiers include vertical blanking interval user bit codes, added video-black and/or audio-black pages between sections, and the like, these identifiers being intended to be automatically read by a PDVR, allowing the user of such PDVR to navigate quickly between sections of step-frame/frame-advance video content.

An alternative to electronic identifiers would be the inclusion of real-time video content that alerts the user to the start of a section of step-frame/frame-advance video content. This could be achieved by inserting a countdown similar to a standard Academy Leader before the start of the step-frame/frame-advance content. Another means would be to insert a real-time video indicator similar to the commonplace internet “loading bar.” before the start of the step-frame/frame-advance content.

The still images 21 may be designed to be viewed in step-frame/frame-advance mode only. Each individual frame 19 may further include still images 21 intended to be viewed in real time as moving images as well as still images 21 intended to be viewed in step-frame/frame-advance mode as still images. Thus, each individual frame 19 may include a section of real-time content 182 and a section of step-frame/frame-advance content 181.

For example, one part of each frame 19, such as the top half of the frame 19, may include images 21 that when viewed sequentially in real time will produce a typical moving image, such as a traditional television commercial with associated sound, while another part of each frame 19, such as the bottom half of the frame 19, may include still images 21, such as one or more photographs, data, and supplemental information, for example from a catalogue or brochure, that are viewable in step-frame/frame-advance mode. Thus, when viewed in real time, the viewer 17 sees a traditional television commercial in the top half of the screen 22 of the viewing device 13. Then when watched in step-frame/frame-advance mode, the viewer 17 will see individual still frames 19 of the commercial in the top half of the screen 22, and individual pages of the content 18, such as a catalogue or brochure, in the bottom half of the screen 22. Current television is technically watched one frame at a time, but is watched at approximately 30 frames per second so that it produces the effect of moving images, whereas the present invention in one embodiment produces content that is viewed one frame at a time at the user's speed so they can read and look at the content in the same way as they would read a book, or catalogue or brochure or other printed matter, etc.

Also, a part of each frame 19 may include images of animated characters or other moving images that when viewed in real time can be seen or heard by the viewer 17. The animated characters or moving images seen in real time may provide information to the viewer 17 on what content 18 can be found in the individual frames 19 when watched in step-frame/frame-advance mode.

Furthermore, the production device 11 may be used to produce a sequence of still images 21 intended to be viewed in real time in combination with a sequence of still images 21 intended to be viewed in step-frame/frame-advance mode. Both of these sequences may then be edited together by adding to create a single final sequence. Editing both sequences together means that the sequence of still images 21 intended to be viewed in real time may be combined with the sequence of still images 21 intended to be viewed in step-frame/frame-advance mode to be connected by adding. The final sequence may include the sequence of still images 21 intended to be viewed in real time and the sequence of still images 21 intended to be viewed in step-frame/frame-advance mode in succession and may have a length equal to the lengths of both of these sequences added together. The sequence of still images 21 intended to be viewed in step-frame/frame-advance mode may be added at the beginning, somewhere in the middle, and/or at the end of the sequence of still images 21 intended to be viewed in real time.

The delivery device 12 may transmit the content 18 final sequence at a standard frame rate or any other frame rate, for example, a faster than standard frame rate, to the viewing device 13 and the recording device 14. The viewing device 13 can receive the final sequence. If content 18 includes sequences of frames 19 that are intended to be viewed in real time, these may be instantaneously viewed by the viewer 17 on the viewing device 13. The recording device 14 may also receive the transmitted final sequence and may record it. The final sequence may be recorded to and saved in a storage medium 23, which may be part of the recording device 14.

The viewer 17 may access content 18 at any desired time thereafter. The recording of content 18 may be played back in step-frame/frame-advance mode using the recording device 14 and may be viewed by the viewer 17 on the viewing device 13 one frame 19 at a time pausing at each individual frame 19 for as long as needed to read the content 18 or for as long as desired, similar to turning the page of a book one page at a time. It may further be possible to move back and forth from frame to frame just like turning pages of a book back and forth.

The recording device 14 may be operated manually to record content 18 that has been transmitted and received. The recording may take place at the same time the viewer 17 watches real-time content 181 in real time on the viewing device 13 or without displaying any content on the screen 22 of the viewing device 13. Additionally, the recording device 14 may be programmed in advance to record content 18 that will be transmitted and received. If the content 18 is encoded, the recording device 14 may be programmed in advance to automatically search for and record content 18 that includes a certain code 25. It may be possible to program a variety of codes 25 to record a variety of content 18. Thus, content 18 containing specific information desired by the viewer 17 may be automatically recorded.

The control device 15 may be remote control operated by the viewer 17. The control device 15 may be used to control the viewing device 13 and the recording device 14. The control device 15 may be used, for example, to turn the viewing device 13 and the recording device 14 on and off, to access the storage medium 23 to select content 18 for replay, and, most importantly, to move forward and/or backward from one frame 19 to the next frame 19 equivalent to turning one page at a time of the original source material, such as a catalogue or brochure. It may also be possible to automatically advance from one frame 19 to another frame 19.

After content 18 has been received, content 18 may also be printed on a printer 24 connected to the recording device 14. Furthermore, content 18 may include links to Web pages so that a viewer 17 while viewing, for example, a catalogue can immediately click on a link to a Web page, where the viewer 17 may place an order. Still further, content 18 may include the ability to directly place a telephone call, for example, to potential advertisers and retailers. Also, the individual frames 19 may include other information and content that are incentives for viewers to record and replay the frames in step-frame/frame-advance mode. For example, these frames 19 may include discount coupons, ways to receive free gifts, competitions, clues to correctly enter and win competitions, news of future television programs, television schedules, recipes, “do-it-yourself” instructions, special promotions, clues to computer games the viewer may own or buy, quiz shows and/or game shows including questions and answers, paid advertisements by other advertisers, and the like. Such content can be produced using a graphics program such as Photoshop, and inserted as individual frames or sections of frames. These frames can then be edited together using an AVID as shown in the examples of how to create step-frame content.

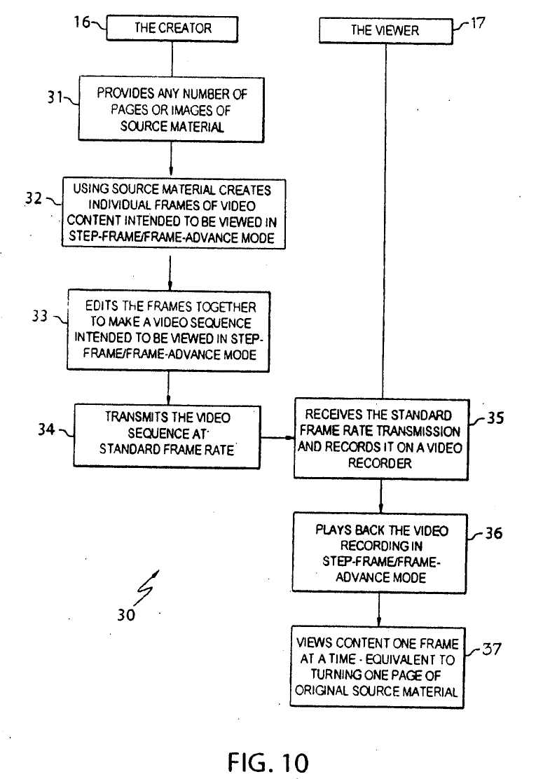

FIG. 10 schematically represents a series of steps involved in a first method 30 for providing step-frame/frame-advance content 181, according to another embodiment of the present invention. Method 30 may involve a step 31, where a creator 16 may provide any number of pages or images of source material of content 18. Step 32 may involve using the source material to create individual frames 19 of content 18, which may be intended to be viewed in step-frame/frame-advance mode. Thereafter, in step 33, individual frames 19 may be edited by the creator 16 by combining a plurality of individual frames 19 to be connected to make a video sequence intended to be viewed in step-frame/frame-advance mode only. The video sequence of the content 18 is then in a step 34 transmitted at a frame rate, for example, a standard frame rate, by the delivery device 12.

Thereafter, the transmitted content 18 may be received and recorded by the recording device 14 in step 35. The following step 36 may involve playing back the recorded content 18 in step-frame/frame-advance mode with the recording device 14 followed by a step 37, where the viewer 17 views the content 18 one frame 19 at a time displayed on the screen 22 of the viewing device 13. Viewing the content 18 may be equivalent to turning the pages of the source material.

After viewing the content 18, content 18 may be saved using a storage medium 23 for repeated viewing at later times or may be printed as reference using the printer 24. Method 30 may also be used, for example, to deliver step-frame/frame-advance content 181, such as, but not limited to, books, research articles, and telephone books (known as “white pages” and “yellow pages”).

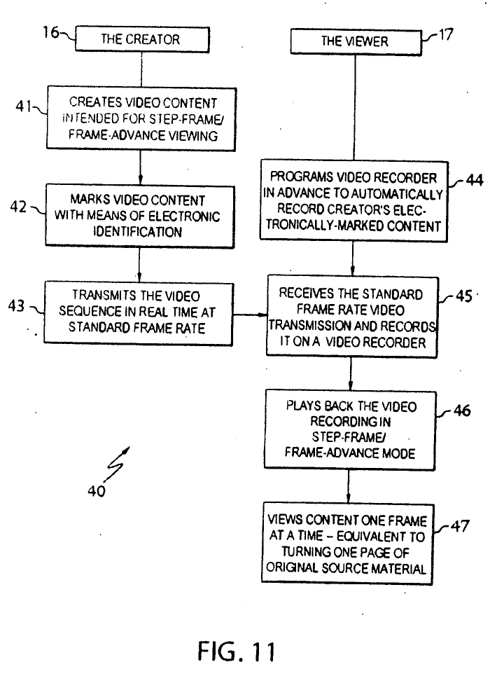

FIG. 11 schematically represents a series of steps in a second method 40 for providing encoded step-frame/frame-advance content 181, according to another exemplary embodiment of the present invention. Method 40 generally differs from above presented method 30 by enabling the encoding of individual frames 19 or sequences of individual frames 19 of the step-frame/frame-advance content 181. Method 40 may involve a step 41, which may involve creating content 18 intended for step-frame/frame-advance viewing only, where a viewer 17 moves forward and/or backward through the step-frame/frame-advance content 181 by viewing a sequence of individual frames 19 one frame at a time, spending as much time looking at one frame as desired, comparable to turning the pages of a book. In step 42, the creator of the content 18 marks the content 18 with means of electronic identification. Therefore, each individual frame 19 or a sequence of individual frames 19 of the content 18 may be provided with a code or descriptive word 25, which allows electronic identification of the specific content 18. Code 25 may be related to the content 18 or other criteria. Thereafter, in a step 43, the content 18 may be transmitted at a standard frame rate or a faster than standard frame rate by the delivering device 12 to the recording device 14.

Independent from and prior to or at the same time as step 43, the viewer 17 may program the recording device 14 to automatically search, identify, and record the transmitted encoded content 18 according to individual criteria of the viewer 17 in step 44. In a step 45, the transmitted content 18 may be received, searched, and, if a desired code is identified, recorded by the recording device 14. The following step 46 may involve playing back the recorded content 18 in step-frame/frame-advance mode with the recording device 14 followed by a step 47, where the viewer 37 views the content 18 one frame 19 at a time displayed on the screen 22 of the viewing device 13. Each individual frame 19 of the content 18 may be displayed on the screen 22 of the viewing device 13 for as long as desired by the viewer 17.

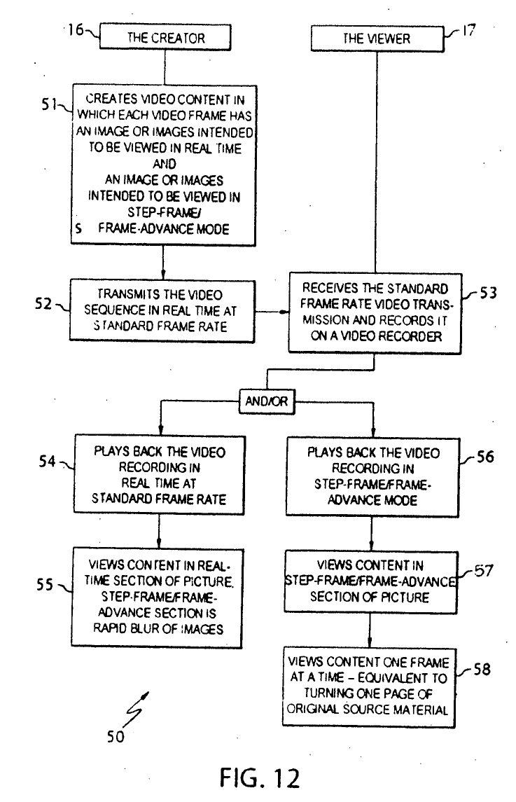

FIG. 12 schematically represents a series of steps involved in a third method 50 for providing real-time content 182 and step-frame/frame-advance content 181 combined in an individual frame 19, according to another embodiment of the present invention. Method 50 generally differs from the above described methods 20 and 30 by enabling combination of the step-frame/frame-advance content 181 and the real-time content 182 in a single individual frame 19. Method 50 may involve a step 51 in which the creator 16 uses the production device 11 to create a sequence of individual frames 19, where each individual frame 19 may include still images 21 intended to be viewed in real-time as well as still images 21 intended to be viewed in step-frame/frame-advance mode. Thus, each individual frame 19 may include a section of real-time content 182 and a section of step frame/frame-advance content 181. A following step 52 may involve the transmission of the sequence of individual frames 19 at a frame rate, for example, a standard frame rate, by the delivery device.

The transmitted sequence of individual frames 19 may be received and recorded by the recording device 14 in a step 53. The transmitted sequence of individual frames 19 may further be received by the viewing device 13 and the still images 21 intended to be viewed in real-time mode may be displayed on the screen 22 and may be viewed by the viewer 17, in a manner such as a typical television program or conventional commercial would be watched. In step 54, the recording may be played back in real-time mode at standard frame rate using the recording device 14 and, in a following step 55, the recording may be viewed in real-time mode at a standard frame rate on the viewing device 13. While the viewer views the real-time content 182 in real time, the step-frame/frame-advance content 181 appears only as a rapid blur of images on the screen 22 of the viewing device.

Furthermore, in a step 56, the transmitted sequence of individual frames 19 may be played back in step-frame/frame-advance mode using the recording device 14. A following step 57 involves viewing the step-frame/frame- advance content 181 in the section of step-frame/frame-advance content 181 of the frame 19. The viewer 17 may view the step-frame/frame-advance content 181 one frame 19 at a time just like turning a page of original source material in step 58.

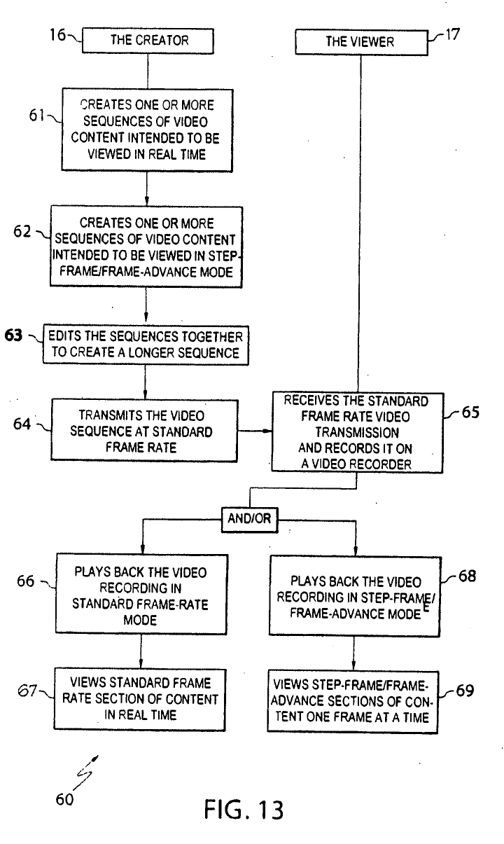

FIG. 13 schematically represents a series of steps involved in a fourth method 60 for providing content 18 by sequentially combining real-time content 182 with step-frame/frame-advance content 181, according to another embodiment of the present invention. Method 60 generally differs from the above described methods 30, 40 and 50 by supplementing the real-time content 182 with the step-frame/frame-advance content 181 such that the real-time content 182 is included in one or more first sequences of individual frames 19 and that the step-frame/frame-advance content 181 is included in one or more second sequences of individual frames 19 that may be put together in succession.

Method 60 may involve a step 61 that involves creating one or more sequences of individual frames 19 of real-time content 182 that are intended to be viewed in real time. A following step 62 involves creating one or more sequences of individual frames 19 of step-frame/frame-advance content 181 that are intended to be viewed in step-frame/frame-advance mode. The real-time content 182 and the step-frame/frame-advance content 181 may relate to a same topic. The creator 16 can edit the sequences including real-time content 182 and the sequences including step-frame/frame-advance content 181 together to be in succession without overlapping to create a final sequence in step 63. A step 64 may involve transmitting the final sequence at a frame rate, for example, a standard frame rate, to the viewing device 13 and to the recording device 14 by using the delivery device 12.

Thereafter, the recording device 14 may receive and record the final sequence in step 65. The final sequence may also be received by the viewing device and the real-time content 182 may be viewed in real-time mode by a viewer 17 instantaneously without prior recording. A step 66 may involve playing back the recorded final sequence in real-time mode and a viewer 17 may view the real-time content 182 in real-time. Furthermore, a step 68 may involve playing back the recorded final sequence in step-frame/frame-advance mode and a viewer 17 may view the step-frame/frame-advance content 181 one frame 19 at a time in step 69.

For example, in one preferred embodiment an advertiser can utilize this method to produce a non-traditional “step-frame/frame-advance” commercial that is in essence 900 pages of a catalogue, brochure, or print advertising campaign. When watched in real time, the pages of the brochure will flash by the viewer. When watched in step-frame/frame-advance mode, however, each individual page will be a discrete frame containing photographs, images and/or data similar to that seen in the print brochure or catalogue, etc. In addition, when such frames are broadcast in “high definition” or “HD” and viewed on a television with high definition capabilities, the photographs, images and/or data may be viewed in high definition, with greatly enhanced clarity and detail, which may be of great value to an advertiser.

In another preferred embodiment, part of each frame, say the top half of the frame, may include images that when viewed sequentially in real time will produce a typical moving image such as a traditional television commercial with associated sound, while another part of each frame, say the bottom half of the frame, may consist of one or more photographs, images, and/or data from a catalogue or brochure. Thus when viewed in real time the viewer sees the traditional high-impact television commercial in the top half of the screen with barely recognizable images in the bottom half of the screen. Then, when watched in step-frame/frame-advance mode, the viewer will see individual still frames of the commercial in the top half of the screen, and individual pages of the catalogue or brochure in the bottom half of the screen.

In yet another preferred embodiment, this method may be used to deliver a range of different catalogues, brochures or other print advertising during a longer period of time, say an hour. For example, the user of this method may buy time from a television channel, in the same way that infomercial producers currently buy time, in order to broadcast such a range. This will allow different advertisers to deliver brochures, catalogues and other print style advertising of different lengths, depending on the number of still images they wish to deliver.

In yet another preferred embodiment, as current and future technologies allow, this method will allow content to be delivered that may include photographs, images and/or data that can be printed on a home printer, such as discount coupons that a viewer can print and take to a store.

In yet another preferred embodiment, as current and future technologies allow, this method will allow content to be delivered that may include links to Web pages, so that a viewer of a catalogue, for example, can immediately click on a link to a Web page where they can then place an order on a Website.

In yet another preferred embodiment, as current and future technologies allow, this method will allow content to be delivered that may include the ability to directly place telephone calls to potential advertisers, retailers, etc.

In yet another preferred embodiment, part of each frame may include images of animated characters, that when viewed in real time can be seen and heard by viewers.

In yet another preferred embodiment, the animated characters or moving images seen in real time may provide information to the viewers on what they may find in the individual frames when watched in step-frame/frame-advance mode.

In yet another preferred embodiment, the animated characters or moving images seen in real time may provide information to the viewers on how they can access the information using step-frame/frame-advance mode.

In yet another preferred embodiment, the individual frames can include other information and content that are incentives for viewers to record and replay the frames in step-frame/frame-advance mode. For example these frames may include discount coupons, ways to receive free gifts, competitions, clues to correctly enter and win competitions, news of future television programs, television schedules, recipes, “do-it-yourself” instructions, special promotions, clues to computer games the viewer may own or buy, quiz shows and/or game shows including questions and answers, paid advertisements by other advertisers, and the like.

In yet another preferred embodiment, this method could be used to provide a viewer with essential information that is difficult to retain as part of a real-time video program. For instance, a half-hour cooking show with an actual running time (excluding commercials) of 23:30 could devote 22 minutes, 14 seconds, and 27 frames to demonstrating the preparation of a dish. It could then include the written recipe and other instructions in 3 step-frame/frame-advance still images.

Production credits for a program could be handled the same way. At present, credits are either a series of “freeze frames” at the end of a program or a “crawl.” In either case, often the individual credits are either on screen for too short a time, in too small a typeface, or “crawling” too rapidly to be legible. But by using the invention, every credit could be legible while taking up negligible real-time running time. Political pecking order could still be observed with the Director getting a frame to himself while the Production Assistants are listed 8 to a frame.

In yet another preferred embodiment, where current and new technologies allow, each frame or series of frames will be coded in such a way that they can be easily identified by such current and new technologies. For example certain PDVR's have a search feature that allows the user to program the PDVR to search for particular programs that may be of interest to the viewer. For example, such PDVR's may be programmed to search for any movie that is being shown on any channel that a particular actor is in. It is thus anticipated that some current and future such devices will allow viewers to program these technologies to search for and record specific content produced under this method, such as catalogues and brochures on particular products. For example, if a viewer is interested in buying a new car, he may program his PDVR to search for and record all brochures being broadcast or shown on all cars, or on a particular brand of car, or a particular type of car (say SUV's) or all cars in a particular price range, and the like. In fact TiVo™ has recently announced that they are working with a number of leading advertising agencies to offer just such a search and retrieve function on future PDVR's for searching and retrieving traditional television commercials.

In yet another preferred embodiment, as current and new technologies allow, content produced under this method can be delivered to and watched/used by viewers who will view this content on any other device that incorporates technology that allows some form of recording of content and some form of playing back such recorded content in step-frame/frame-advance mode, such as future versions of PC's, laptop computers, cell phones, PDA's, etc.

In yet another preferred embodiment, producers may use this method to enhance actual programs rather than commercials. For example, producers of game shows or quiz shows may use such techniques to allow viewers to participate in a quiz or game show from home by posting a series of questions that viewers can record and later view in step-frame/frame-advance mode. In another example, producers of a documentary may use such techniques to send the viewer additional background information on the program or subject being covered in the documentary, or details on how to donate to a charity supporting a cause being covered in a particular program, or how to buy DVD's of the program, etc. A producer of a drama show or sitcom may send viewers information on how to purchase clothing or props that are similar to those being worn or used by the cast, etc.

In yet another preferred embodiment, this method may be used to deliver other forms of written material and/or photographs. For example step-frame/frame-advance could be used to view books, to research articles, and the like that have been sent to the viewer and recorded on their recording devices.

In yet another preferred embodiment, this method may be used to allow viewers to read and answer test questions. For example, a viewer may be able to take his Real Estate examination on a television screen using step-frame/frame-advance pages.

In yet another preferred embodiment, this method may be used to deliver other information about programs or commercials; i.e. legal disclaimers/medical side-affects, warnings, and other mandatory legal copy. Currently, many TV advertisers must include visible mandatory legal disclaimer copy in their real-time commercial broadcasts. Some examples are promotions of sales, contests, lotteries, ads for pharmaceuticals, etc. While law mandates these disclaimers, each TV and cable network has its own staff to enforce and interpret compliance in individual commercials. Thus, a nationally broadcast TV commercial, to satisfy the compliance criteria of, say, NBC™, CBS™, ABC™, FOX™, CNN™, and ESPN™, may have to be produced with 6 different versions of the on-screen disclaimer language, with 6 different requirements for the size and kind of typeface.

Aside from the production difficulties, advertisers dislike the superimposition of these disclaimers onto their video footage because it detracts from the aesthetics and impact. So they try to make the disclaimers as brief and in as small a typeface—as invisible—as the individual networks will allow. While intending to comply with the law, the networks also try to please their paying customer, the advertiser. So inevitably, often following prolonged acrimonious negotiation, a compromise is reached whereby the onscreen disclaimer is both unsatisfactory to the advertiser and illegible to the viewer. It's an all around losing proposition.

The invention, however, can provide the ideal solution to this problem. By creating a single or multiple images of the disclaimer language to be viewed in step-frame/frame-advance mode: 1. The effectiveness and impact of the advertiser's video footage would be undiminished, 2. Production of the various network versions would be easier, faster, and less expensive, and 3. The viewer would actually be able to read it.

In yet another embodiment: an advertisement for a car. The video content consists of a 300-frame sequence. The top ¾ths of each frame is a different still image of the car. The bottom ¼ of each frame, however, says this: “SNEAK PEEK . . . THE ALL NEW FORD MUSTANG™.” So when the viewer initially sees the advertisement in real time, he sees 10 seconds of the words “SNEAK PEEK . . . THE ALL NEW FORD MUSTANG™” at the bottom of the picture (and, perhaps, hears a voiceover saying, “Here's a sneak peek at the all-new Mustang!”), while the top of the picture is a 10-second blur of rapidly changing images.

Then when the viewer step-frame/frame-advances through the same material, he sees up to 300 different still images, possibly including but not limited to: the exterior of the car; the interior; the engine compartment; safety features; mileage data; available optional equipment; color choices; warranty information; pricing; in the top ¾ of the 300 frames.

In yet another embodiment: a TV network self-promotion. The video content consists of a 150-frame sequence. The face of an animated character is in a square insert at the top left of each frame. As the content plays in real time (5 seconds), the animated character says, “Hey kids! Check it out! It's all happening right here on KIDS' WB!™.

When the viewer step-frame/frame-advances through the video, he finds many kinds of promotional content, possibly including but not limited to: single-frame promotions with images and captions for upcoming shows; multiple-frame promotions, etc. For example, in a multi-frame promotion, Frame 1 contains the text “On the next CowBots . . .”; Frame 2 contains the text “. . . when Sheriff Cy Borg tracks down Mad Morphin' Murphy”; Frame 3 contains the text “. . . it's mano a mano in a shape-shiftin' showdown!”; Frame 4 contains the text ‘Next CowBots. Right after America's Funniest Anime Bloopers on KIDS’ WB!™” Additional frames may include contest information/clues; celebrity trivia; paid advertisements by other sponsors; “behind the scenes/making-of” images from animated or live-action shows; daily/weekly programming schedules, etc.

In another embodiment: a shared local-advertisement “pod.” Multiple advertisers would share the video content. In one example a 5-second (real time) local broadcast in the hypothetical town of Smootville would have a 5-second “banner” of text at the bottom of the picture reading: “FINE DINING IN SMOOTVILLE.” Various local restaurants would purchase either a single advertising frame or multiple frames and insert either a single image or multiple images within these frames to promote their establishments. A single-frame ad might be a simple name, address, operating hours and phone number. A multiple frame ad would possibly include but would not be limited to images of the restaurant interior, the food, the staff, the menu, etc.

In another embodiment: a shared national-advertisement “pod.” As in the previous example multiple advertisers would share the video content, but in this use, both the transmission and the target audience would be nationwide. By purchasing, at minimum, 1/30th of a second (or 1 frame) of national TV time, an advertiser could reach a targeted national audience at comparatively low cost. An example: during a national transmission of “It's a Wonderful Life,” a short “pod” is broadcast with the bottom text “banner” reading “CHRISTMAS TREES FROM MAINE.” The step-frame/frame-advance content would consist of numerous single- or multi-frame ads promoting individual Maine Christmas tree grower/shippers.

In another embodiment: a replacement for the traditional paper catalogue. The escalating costs of printing and shipping traditional paper catalogues have already driven some of the largest ones—for example those of Sears™, JC Penney™, etc.—into extinction. However, by utilizing this method, catalogue content can be delivered to millions of consumers almost instantly, with no paper, printing, mailing, or fuel costs.

For example, at 30 pages (frames) per second, the 192-page Winter 2005 Staples™ catalogue can be delivered under this method (transmitted and recorded) in 6.4 seconds, without any paper, printing, mailing, or fuel costs.

In another embodiment: a catalogue delivered as part of a traditional “real time” TV commercial. Catalogue content would be included in the video content of a traditional commercial. As an example, again for Staples™, a TV voiceover might say, “You'll want to record this commercial, because now through Sunday, you can get 10% off our already-low catalogue prices on everything in the store. And speaking of the catalogue . . . , you're recording it right now!” The catalogue is then delivered as part of the commercial utilizing this method.

In another embodiment: automatic recording of catalogues and other content. Catalogues and other forms of content with high numbers of individual images would be scheduled to be broadcast at specific times. The audience member could then program his video recorder to receive and record that content automatically (using already-existing technology), to be played back at a later time.

In another embodiment: step-frame/frame-advance content for entertainment. The video content looks like any other traditional video when played at normal speed. However when viewed in step-frame/frame-advance mode, the content is revealed to be humorous or otherwise entertaining. An example would be video of a railroad crossing. At normal playback speed, a freight train whizzes by at 70 miles per hour. But when viewed in step-frame/frame-advance mode, the individual freight cars have jokes written on them.

In another embodiment: a replacement for the traditional telephone alphabetical order residential and business listings book, also known as a “white pages”. The traditional “white pages” phone book must first be printed and then hand-delivered to individual customers. Multiple books are often delivered to a single customer. These phone books are often large and heavy. For example, the SBC™ September 2004 Greater Los Angeles White Pages for Area Codes 323 and 213, which covers far less than half of the metropolitan area, runs some 775 pages and weighs over 4 pounds. It would be even bigger if SBC™ didn't use extremely small type to accommodate approximately 550 entries per page (5 columns×approximately 110 entries per column). Further, these traditional phone books are only updated, published and delivered once a year. Because of the time it takes between the update and delivery, traditional white pages are already outdated by the time they're delivered. And at the end of the yearly cycle, of course, they're even more outdated. Further, large metropolitan areas are often covered by multiple phone books, so a person trying to look up a number might not know which book he should be looking in. For example, imagine you're looking for the number of a person and all you know is his name and the fact that he lives somewhere in the Los Angeles area. He could live in Hollywood, Santa Monica, Burbank, Long Beach, Simi Valley, Saugus, or Pasadena. Each has a different area code and is covered by a different phone book. You either have to look in all 7 phone books (which you are unlikely to have) or you have to call Directory Assistance up to seven times, and be charged separately for each inquiry.

The invention, however, could be used to replace the traditional “white pages” phone book. There are several advantages, including but not limited to: no printing costs; no delivery costs; easily (and continuously) updateable; easier to read—there's no need to make the typeface small; wider coverage. Let's assume that in the case of the Greater Los Angeles directory, it is doubled in size to 1550 pages, so the typeface can also be twice as big. Further, let's assume that the other 6 Los Angeles-area directories are also 1550 pages each. So a “master” Los Angeles white pages directory (or PDVR White Pages) would be 10,850 pages in length. At 1 page per video frame, it could be transmitted and recorded in less than 6 minutes and 2 seconds.

In another embodiment: a replacement for the traditional telephone business listings book or “yellow pages”. The traditional “yellow pages” phone book must first be printed and then hand-delivered to individual customers. Multiple books are often delivered to a single address. These phone books are often large and heavy. For example, the SBC™ September 2004 Greater Los Angeles Yellow Pages for Area Codes 323 and 213, which covers far less than half of the metropolitan area, runs some 1060 pages and weighs over 5 pounds. It would be even bigger if SBC™ didn't use extremely small type to accommodate 5 columns of entries per page, with approximately 110 entries per column, not including display ads. Further, these traditional phone books are only updated, published and delivered once a year. Because of the time it takes between the update and delivery, traditional yellow pages are already outdated by the time they're delivered. And at the end of the yearly cycle, of course, they're even more outdated. Multiple yellow page books often cover large metropolitan areas, so a person trying to look up a number might not know which book he should be looking in. For example, imagine you're looking for the number of a business and all you know is its name and the fact that it is located somewhere in the Los Angeles area. That business could be in Hollywood, Santa Monica, Burbank, Long Beach, Simi Valley, Saugus, or Pasadena. Each has a different area code and is covered by a different phone book. You either have to look in all seven phone books (which you are unlikely to have) or you have to call Directory Assistance up to seven times, and be charged separately for each inquiry.

The invention, however, could be used to replace the traditional “yellow pages” phone book. There are several advantages, including but not limited to: no printing costs; no delivery costs; easily (and continuously) updateable; easier to read—there's no need to make the typeface small; wider coverage.

Let's assume that in the case of the Greater Los Angeles directory, it is doubled in size to 2120 pages, so the typeface can also be twice as big. Further, let's assume that the other six Los Angeles-area directories are also 2120 pages each. So a “master” Los Angeles yellow pages directory (or PDVR Yellow Pages) would be 14,840 pages in length. At 1 page per video frame, it could be transmitted and recorded in less than 8.5 minutes. In actuality, the Los Angeles PDVR Yellow Pages would probably be much smaller because many businesses currently run display ads in multiple (paper) yellow pages directories, and that redundancy would be cut out.

Another advantage is single-category recording. When, as it is anticipated will be the case, every PDVR Yellow Pages entry is “tagged” according to its business category, it would be possible to program a PDVR to automatically record only the section or category a consumer wants. (Being alphabetized, the PDVR Yellow Pages would already be organized in those distinct sections.) Let's say you need a new roof. The “Roofing” section of the September 2004 SBC Greater Los Angeles Yellow Pages runs five and a half pages. So, using our previous method of extrapolation, there would be a total of approximately 38.5 pages of Roofing listings in the seven Los Angeles area Yellow Pages editions. Assuming there's no redundancy, at 1 page per video frame it would take less than 1.5 seconds to transmit and record the listings of every Los Angeles-area roofer.

In another embodiment: government and public service applications. The invention could be used to deliver images and information that are in the public interest. Examples include but are not limited to: missing persons; wanted fugitives; registered sex offenders; parolees.

Many parolees are severely restricted in their residence and travel options. By publicizing those restrictions, the public can potentially become aware that a person has violated his parole even before his parole officers find out.

In another embodiment: delivery of corporate annual reports. Public companies are currently required to print and mail annual reports to every stockholder. These annual reports are often costly both to print and to mail. And, ironically, doing so adversely affects those companies' profits and reduces the value of their shares.

Once the use of the invention becomes commonplace, it is anticipated that government regulations will be amended to allow companies to disseminate their annual reports using the invention.

In another embodiment: compulsory public notices. Many if not all local, county and state governments require business entities to publish notices (“statements”) in newspapers announcing the establishment of or changes in their businesses. An example would be the Los Angeles County Fictitious Business Names Statement requirement. For example, prior to opening a business, a business name must be selected that is not already in use and then registered. Business and Professional Code 17918 specifies “No person transacting business under a fictitious business name contrary to the provisions of this chapter, or his assignee, may maintain any action upon or on account of any contract made, or transaction had, in the fictitious business name in any court of this state until the fictitious business name statement has been executed, filed, and published as required by this chapter . . . state law requires that within 30 days the registrant must publish a statement in a newspaper of general circulation in the county in which the principal place of business is located.”

Once the use of the invention becomes commonplace, it is anticipated that government regulations will be amended to allow businesses to publish such statements using the invention.

One of the main benefits of the current invention is that whereas many viewers would typically use these new technologies to fast-forward or skip through traditional commercials that they will then never watch, it is anticipated that many of these viewers will be more inclined to record and watch step-frame/frame-advance commercials in the same way that they save and re-read print catalogues and brochures.

Another benefit of the current invention is that brochures and catalogues need no longer be printed and/or mailed.

Another advantage of the current invention is that there will be less waste of paper and postage to customers who have no interest in the products or services whatsoever.

Another advantage of the current invention is that catalogues, brochures, and print ads delivered by the current method will be much easier to store and access on a PDVR's or similar device.

Another advantage of the current invention is that it makes no difference if the viewer decides to skip over a commercial when watching a program, as they really need to watch this in step-frame/frame-advance mode in any event.

Another advantage of the current invention is that if PDVR's ultimately lead to the demise of the traditional television commercial, as some people are anticipating, then advertisers can use block purchases of time to broadcast content produced using the current method which can then be automatically recorded by PDVR's and similar devices to be watched at a later time at the viewer's discretion.

Another advantage of the current invention is that advertisers can get across a lot more information in a particular timeframe, such as within a 30-second spot, so that advertisers may share such time slots with other advertisers thus reducing their media buying cost.

Another advantage of the current invention is that the invention will allow for direct-mail-catalogue-style marketing in categories where it never previously existed. One such category might be vacation time-shares. A marketer of time-shares in a vacation property could produce a 30-image “catalogue” (deliverable in 1 second) and theoretically buy 1/900th of a half-hour of a late-night TV time slot, along with 899 other marketers of time-shares all over the world. The viewer/customer would then program his PDVR or similar device to record that late night broadcast, and then be in possession of 900 different 30-image time-share catalogues.

Another advantage of the current invention is that the drastically reduced production and delivery costs compared to traditional catalogues and brochures will “democratize” many product categories. In a category like, say, autos, manufacturers have always produced high-quality catalogues and brochures, but they've typically only made them available in their dealer showrooms, as the cost of these typically does not justify them sending these to people's homes through the mail. But the current invention will enable auto manufacturers to deliver those catalogues directly to the homes of a much wider audience of potential buyers who have not yet been enticed into the showroom, and at a significantly reduced cost. And those catalogues can contain much more information than before, since they don't have to be printed or mailed. An auto catalogue could have images of every model in every color from multiple angles. Consumers will also like this, as they will now be able to access the latest auto catalogues without having to go to the showroom.

Another advantage of the current invention is that the invention will make possible the creation of a “commercial/catalogue” hybrid in which, say, 27 seconds of a 30 second video production would be a traditional TV commercial message, but the other 3 seconds would contain a 90-page catalogue. So a retailer like IKEA™, who traditionally has done both TV commercials and direct catalogue mailings, could combine both in one video execution while eliminating all printing and postage costs.

Yet another advantage of the current invention is that at present, retailers who rely heavily on mailed catalogues and brochures must price their goods to offset the costs of catalogue or brochure printing and postage. By utilizing the invention, that portion of the retailers' overhead would be eliminated, enabling them to reduce prices across the board with no compromised in quality or profitability. Also, new startup companies utilizing the invention can spend far less (or none) of their initial capital on traditional direct marketing, making their odds of success much greater. These startups will also be better able to undercut the pricing of their bigger, established, direct-mailing competitors, driving prices down in general and benefiting consumers.

Another advantage of the current invention is that a viewer will be able to view the information and photographs within these individual frames in very high quality and in a much larger size than available in current print ads, brochures or catalogues. For example, a viewer who owned a large high definition television would be able to view these images as equally large high definition images. Advertisers have already recognized the potential impact of using high quality photographic images in their current brochures, catalogues, and print ads, such as those used in glossy magazines. Thus advertisers will likely find the ability to deliver even larger high quality images a distinct marketing advantage over their competitors who do not use the current method.

Another advantage of the current invention is that marketers may use the method to deliver catalogues and other Step-frame content via the internet, through streaming or other means, as a form of “push technology” or “push marketing.” Traditionally, internet users typically receive noncommercial video content such as news or entertainment by visiting a Website and clicking on a link to such content, thus “pulling” the content. Advertisers, however, often prefer to “push” marketing content, which they currently achieve by attaching it to the “pulled” noncommercial content, for example, where an advertiser attaches a video commercial to a news clip requested by the user. Thus advertisers can use the current invention to attach a piece of Step-frame Content such as a catalogue to the beginning of a piece of pulled” noncommercial content. This has the advantage of allowing the advertiser to deliver a catalogue or similar piece of Step-frame Content to viewers for a wide range of news and/or entertainment content by “pushing” such content to such users as opposed to relying on users visiting the advertiser's Website and requesting, or “pulling” such content.

Because the location and length of step-frame/frame-advance content included within a video presentation may vary considerably, it will therefore become useful to “code” the content so that a user's video recording device (such as a PDVR, set-top box, or PC-based video viewer) can automatically detect, identify, and interpret the step-frame/frame-advance content. Coding of frames is well known and practiced by those having skill in the art of the invention. Coding takes only a small fraction of the data contained in a single frame of video and can be accomplished without noticeably affecting playback or viewing. A video recording device capable of automatically detecting coded video frames, identifying the type of content, and interpreting that content in terms of its relationships to other coded frames would enable a wide range of new and useful functionality.

Various methods for coding or “tagging” individual video frames to trigger various actions are known and practiced in the art. For example, such systems are typically used for verifying that advertisements have been properly broadcast. Tagging methods include encoding portions of the vertical blanking interval (VBI), as described in U.S. Pat. No. 4,805,020 issued to Greenberg, or in the audio portion of the signal, as described in U.S. Pat. No. 4,945,412 issued to Kramer. Other methods include those described in U.S. Pat. No. 6,947,598 to Yogeshwar, et al. titled “Methods and apparatus for generating, including and using information relating to archived audio/video data,” and U.S. Pat. No. 6,535,253 to Barton, et al. titled “Analog video tagging and encoding system”, which are incorporated herein in their entirety by reference. These tagging schemes include the ability to add indexing metadata to individual digitized video frames without interfering with the ability of the video recording device to read the originally created video file. During playback, high-speed electronics can provide automatic real-time detection, and copying or cutting of the tagged step-frame/frame-advance portions of the video stream. These tagged frames can then be archived in any convenient data storage medium, for example on a hard drive or in flash memory, for later retrieval. Buffering of the video stream by the video recording device can be used, if necessary, to eliminate time gaps during playback due to removal of the tagged video frames.

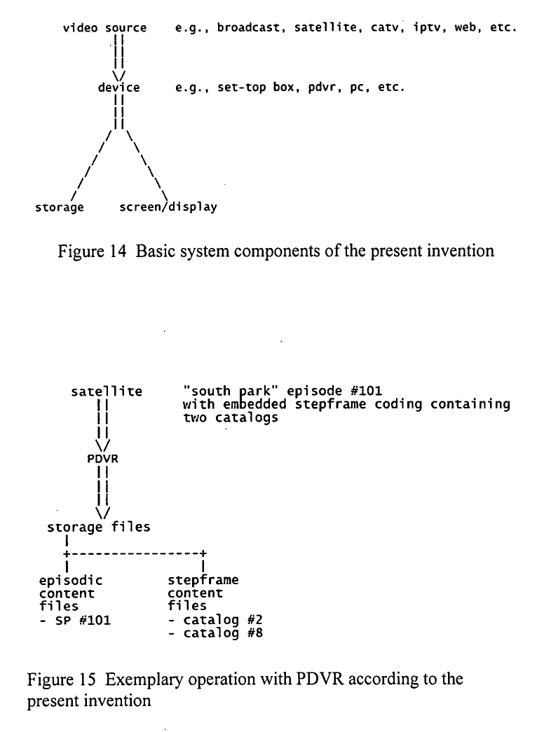

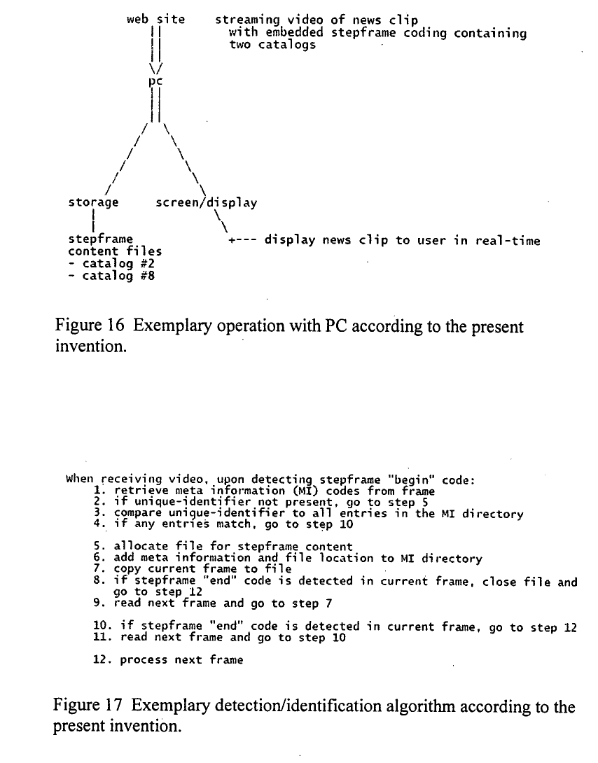

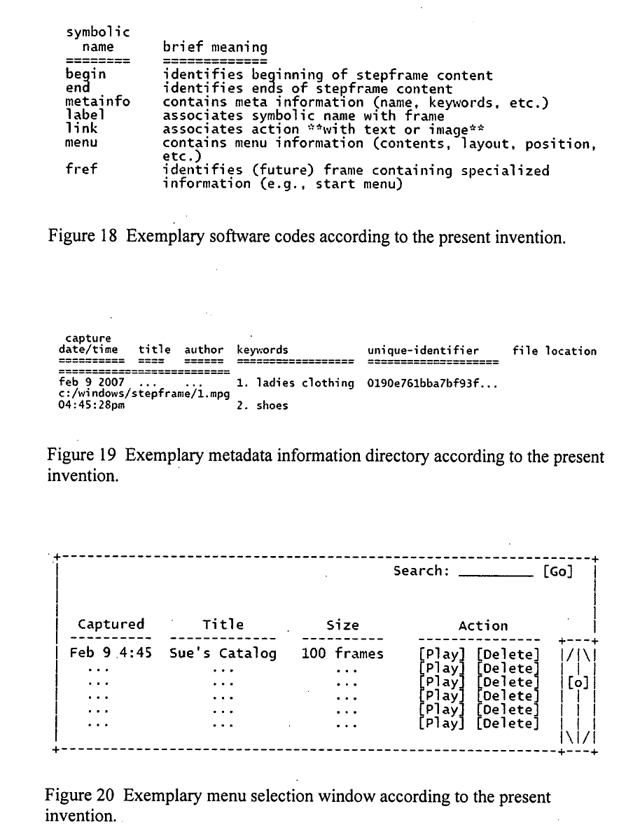

FIG. 14 depicts a flow diagram showing the basic components of the video coding scheme described above. Any of the many available types of video streams enters the video recording device, which then detects, identifies, and then stores the tagged video content while directing the untagged content to a viewing screen or display, preferably in quasi-real time. FIG. 15 presents a flow diagram for a particular exemplary embodiment wherein an episodic television show such as “South Park” is embedded with step-frame/frame-advance content comprising two catalogs, catalog #2 and catalog #8. The PDVR video recording device separates and stores the two catalogs in a separate memory location from the episodic content files, SP #101. In yet a third exemplary embodiment, FIG. 16 depicts a flow diagram in which streaming news video from a Website is directed to a PC having a video recording device capability that stores the two catalogs while presenting the streaming news video in real time. This represents a significant advantage over previous PC-based devices in which streaming video is typically permanently stored in its entirety or not at all. Accordingly, the separation of step-frame/frame-advance content from the “main” content is of vital improvement.

Many video recording devices already provide means for storing video content for subsequent playback, so that automatically detected step-frame/frame-advance content can be automatically saved, independent of any actions taken on the host video stream. This action may be taken regardless of whether or not the video recording device is “recording” the video stream in its entirety or not. Because of the relatively small memory required to save the step-frame/frame-advance data, even set-top boxes with no explicit ability to record episodic video can easily provide the small amount of memory needed for storing the tagged content using, for example, flash memory or other convenient media types. The video recording device may record step-frame/frame-advance data automatically, or may operate according to user input preferences such as “never”, “always”, or “ask”.

Many other functions become available for video recording devices capable of detecting step-frame/frame-advance content. For example, when implemented on a PC or other computer system, a video viewing program may be configured to store the step-frame/frame-advance content in a condition and format for use by other applications such as media center software. This functionality would allow program developers to make the step-frame/frame-advance content available to applications that are not “step-frame knowledgeable”.

In addition to providing coding that detects the step-frame content, coding that identifies the step-frame/frame-advance content is also useful. Metadata, such as name, author, keywords, unique-identifier, etc., may also be embedded within the step-frame/frame-advance video content. Embedding metadata allows a video recording device to make more intelligent decisions. For example, if the step-frame/frame-advance content contains a unique-identifier, and if, later on, new step-frame/frame-advance content is detected with the same unique-identifier, the video recorder device need not capture it a second time. FIG. 17 presents an exemplary algorithm for detecting and identifying coded step-frame/frame-advance video frames containing metadata information in addition to unique identifier and “end” codes. FIG. 19 depicts an exemplary metadata information directory showing certain exemplary attributes.

In another example of unique functionality that is enabled by the present invention, the viewer may indicate that step-frame/frame-advance content conforming to certain user selected search criteria, such as keywords, be automatically captured. This functionality would allow a viewer interested in “luxury cars” to specify this as a keyword to the video recording device, which in turn would automatically capture any step-frame/frame-advance content encountered having that keyword.

The video recording device may also provide the viewer with means to exercise choices and preferences. In one exemplary embodiment, the video recording device may provide a “selection window” to the viewer (available via pull-down window or some other user-interface artifact) allowing the viewer to review all captured step-frame/frame-advance content. FIG. 20 depicts an exemplary selection window that would appear on the video display and which provides the viewer with convenient means to make selections regarding disposition of the step-frame/frame-advance content according to their personal preferences. The review process allows the viewer to order or filter the content based on different criteria, such as date and time of capture, name, keywords, and so on. These interactive features allow the viewer to easily identify the desired step-frame/frame-advance content, and to select it for viewing, deletion, and so forth.

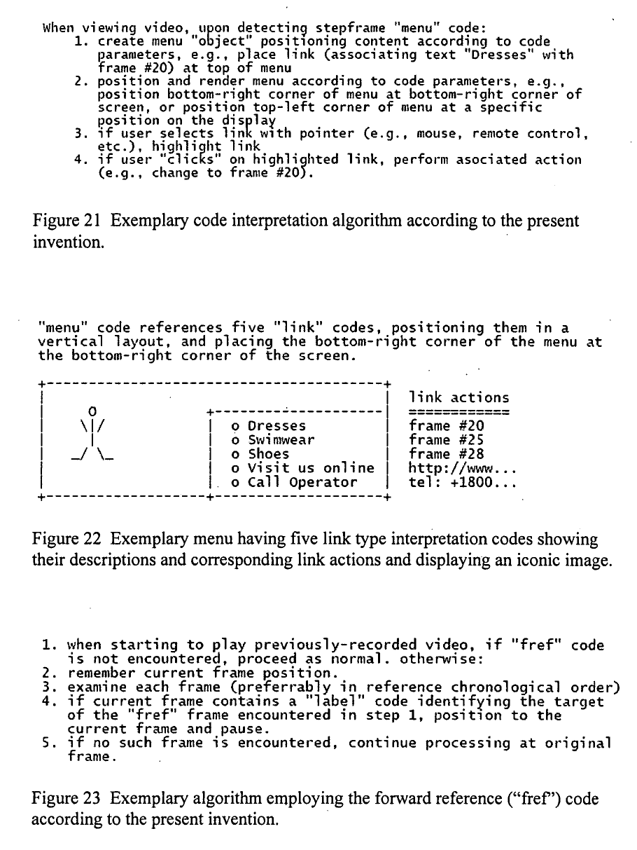

In addition to providing coding that detects and identifies the step-frame/frame-advance content, coding that interprets the step-frame/frame-advance content is also useful. These embedded codes are used for purposes such as providing links between frames (“internal links”), or links from a frame to a resource outside the step-frame/frame-advance content (“external links”). At its most basic, an internal link references another frame in the step-frame/frame-advance content. This provides functionality necessary to implement a “table of contents” or similar capability to allow a user to “jump” to a specific page, either by clicking on a link in a menu, or entering a frame number into a form, and so on. Note that internal links contain not only a pointer (e.g., “go to frame #7”), but also indicate whether the viewer should freeze at the frame or start playing. This dual “pointer” and “mode” ability allows internal links to support a wide-range of applications for the viewer. FIG. 21 presents an exemplary interpretive algorithm that demonstrates how codes embedded within the step-frame/frame-advance frames can be used to create relationships in links that provide enhance functionality.

There are several ways in which external links may also prove useful. For example, if a link to an Internet Uniform Resource Locator (“URL”) is present, then an Internet-connected video recording device can allow the viewer to reference the link and open up a Web browser to that page. Similarly, if a link references a telephone number, then a video recording device connected to the telephone network can dial that number to connect to a recorded message, consumer service representative, and so forth. Similarly, if a link references a printer, then a video recording device connected to a printer (either directly or through a data network), can, at the consumer's request, print the indicated frame or frames.

In many cases, links will offer choices to the viewer and, therefore, must be displayed. Thus, links are associated with menu coding that indicates the layout and positioning of a menu within the frame associated with the menu. This functionality is not unlike the menu capability found with DVD's and other kinds of physical storage media. However, it differs significantly in implementation. FIG. 22 depicts an exemplary viewer menu comprising an image and including links to related subjects, and showing their corresponding link actions.

For example, the frame associated with a “table of contents” might contain a still image of a background, along with menu coding and associated internal link coding for each category contained within the step-frame/frame-advance content (e.g., “lingerie”, “socks”, “scarves”). The viewer's video recorder device is responsible for interpreting the menu coding to render the appropriate menu to the view for a given frame. In another embodiment, internal link references or pop-up menus may be used to allow a viewer to use a remote control or keyboard or PC mouse to jump to a particular page, identified by a page number, or the beginning of a particular section of the step-frame/frame-advance content, such as the “swimwear” section of a clothing catalog, identified by a keyword, page number, or other identifier; e.g., by associating an image with an action using the “link” code.

Interpretive coding of frames need not necessarily appear at the chronological beginning of the step-frame/frame-advance content. In the case of live broadcasts, for example, it may be more feasible to encode this information into the final frames of the broadcast. Accordingly, in addition to allowing link references, there are also anchor codes that associate with a frame a symbolic identity. These anchors can be viewed as being analogous to “chapter stops” or “page numbers” in that they do not “point to something else” but, rather, “something else points” to them.

Codes used for detection, identification, and interpretation of video frames are not limited to step-frame/frame-advance content. In fact, the principles described herein for utilizing frame coding can be applied to any video content, regardless of whether it is intended for viewing in step-frame/advance-frame mode. That is, any content, such as a movie, news broadcast, or episodic show, and whether intended for delivery to a PDVR, PC, Cell Phone, or other device with recording capabilities, can contain the three types of coding described above, and for which these devices may be adapted for detecting and processing such codes. Additional types of codes may be used for other purposes applicable to real-time viewing; for example, for nesting (e.g., to identify commercial breaks). Even live content broadcasts can potentially contain coded frames; e.g., a special code at the beginning of the program can direct the video recording device to look at the end of the content for a “start menu” that makes reference to earlier codes in the video thereby enabling the device to organize the earlier content. FIG. 23 presents an exemplary algorithm that utilizes future reference frame or “fref” code that identifies a subsequent or “future” frame to look for that contains specialized information such as a start menu, etc. As with step-frame/frame-advance content, parts of the coded video content may be stored separately. For example, if codes are used to identify commercial breaks, that content may be stored separately from the “main” content.

This functionality is applicable to any type of content coded within the video and offers a much richer experience to the view. For example, currently when a movie is recorded from a video broadcast using a PDVR, chapter stops or menus are not included in the broadcast. However, if the interpretive coding described above were included in the video stream, this functionality would then become available to the video recording device, providing options previously only available with DVD and similar types of media. Similarly, when a movie is downloaded to a PC there are also no chapter stops or menus but, once again, the interpretive coding described above could be included to make this functionality available to the user. Accordingly, this present invention is not limited to step-frame/frame-advance content, but applies to all forms of video content in any format including, but not limited to, NTSC, SECAM, PAL, HDTV, IPTV, etc.

It should be understood that the foregoing relates to exemplary embodiments of the invention and that modifications may be made without departing from the spirit and scope of the invention as set forth in the following claims. Accordingly, the inventions should not be limited based on the described embodiments. Rather, the scope of the inventions described herein should only be limited in light of the claims that follow when taken in conjunction with the above description and accompanying drawings.

What is claimed:

1. A system for processing a video data stream comprising:
a receiving device configured to receive and process a signal having a known video format, comprising frames, the device further configured to output a signal in a format suitable for viewing on a display device; and
circuitry configured to detect a particular digital code located within an individual frame of the processed signal, the code identifying a type of frame; and
the circuitry further configured to store the identified frame in a retrievable memory location of the system.

2. The system of claim 1, wherein said identified frame has content uniquely suitable for step-frame/frame-advance viewing.

3. The system of claim 1, wherein said identified frame comprises an additional metadata code relating to a content of the frame.

4. The system of claim 3, wherein the metadata code comprises information selected from at least one member of the group consisting of a unique frame identifier, a unique frame sequence identifier, a name, a date, an author, a key word, a content index, a selection menu, the identity of another frame, a link to another frame, and a link from another frame.

5. The system of claim 3, wherein the metadata code includes a link to another resource selected from at least one member of the group consisting of an Internet URL, a telephone number, and another frame.

6. The system of claim 1, wherein said retrievable memory location is selected from at least one member of the group consisting of a hard drive, flash memory, EEPROM, and an optical storage disk.

7. The system of claim 1, wherein said digital format is selected from the group consisting of the video digital formats of the Motion Pictures Expert Group (MPEG), the International Telcommunication Union ITU-T, AVS, Bink, Dirac, Indeo, MJPEG, RealVideo, Theora, VC-1, VP6, VP7, and WMV.

8. The system of claim 1, wherein the system is the type of system selected from the group consisting of a set top box, a personal digital video recorder (PDVR), a personal digital video recorder (PDVR) connected to a personal computer, a personal computer, a digital video disc recorder (DVDR), a video cassette recorder (VCR), a game console, a personal data assistant (PDA), a digital media player, and a multimedia cell phone.

9. The system of claim 1, wherein some non-identified frames are stored in a memory location separate from the coded frames.

10. The system of claim 1, wherein some identified frames are stored in a memory location separate from the other identified frames.

11. A method of processing a video data stream comprising the steps of:
converting a signal having a known video format comprising frames into a signal in a format suitable for viewing on a display device;
detecting a particular digital code located within an individual frame of the processed signal identifying a type of frame; and
storing the identified frame in a retrievable memory location.

12. The method of claim 11, wherein said identified frame has content uniquely suitable for step-frame/frame-advance mode viewing.

13. The method of claim 11, wherein said identified frame comprises an additional metadata code relating to the content of the frame.

14. The method of claim 13, wherein the metadata code comprises information selected from at least one member of the group consisting of a unique frame identifier, a unique frame sequence identifier, a name, a date, an author, a key word, a content index, a selection menu, the identity of another frame, a link to another frame, and a link from another frame.

15. The method of claim 13, wherein the metadata code includes a link to another resource selected from at least one member of the group consisting of an Internet URL, a telephone number, and another frame.

16. The method of claim 11, wherein said retrievable memory location is selected from at least one member of the group consisting of a hard drive, flash memory, EEPROM, and an optical storage disk.

17. The method of claim 11, wherein said digital format is selected from the group consisting of the video digital formats of the Motion Pictures Expert Group (MPEG), the International Telcommunication Union ITU-T, AVS, Bink, Dirac, Indeo, MJPEG, RealVideo, Theora, VC-1, VP6, VP7, or WMV.

18. The method of claim 11, wherein the system is the type of system selected the group consisting of a set top box, a personal digital video recorder (PDVR), a personal digital video recorder (PDVR) connected to a personal computer, a personal computer, a digital video disc recorder (DVDR), a video cassette recorder (VCR), a game console, a personal data assistant (PDA), a digital media player, and a multimedia cell phone.

19. The method of claim 11, wherein some non-identified frames are stored in a memory location separate from the coded frames.

20. The method of claim 11, wherein some identified frames are stored in a memory location separate from the other identified frames.
